(19) United States
(12) Patent Application Publication
(10) Pub. No.: US 2025/0082161 A1
(43) Pub. Date: Mar. 13, 2025

(54) METHOD AND DEVICE FOR ACTIVATING BATTERY DRIVING DEVICE BY ELECTRONIC SWITCH

(71) Applicant: Samsung Electronics Co., Ltd., Suwon-si (KR)

(72) Inventors: Seongu LEE, Suwon-si (KR); Yongseok KIM, Suwon-si (KR); Sanghyuk PARK, Suwon-si (KR); Seho PARK, Suwon-si (KR); Sanghoon BAE, Suwon-si (KR); Yeongju LEE, Suwon-si (KR); Jaeshik JEONG, Suwon-si (KR)

(73) Assignee: Samsung Electronics Co., Ltd., Suwon-si (KR)

(21) Appl. No.: 18/952,381

(22) Filed: Nov. 19, 2024

Related U.S. Application Data
(63) Continuation of application No. PCT/KR2023/004808, filed on Apr. 10, 2023.

(30) Foreign Application Priority Data
May 20, 2022 (KR) 10-2022-0062338
Feb. 1, 2023 (KR) 10-2023-0013890

(51) Int. Cl. A47L 9/28; H02J 7/00

(52) U.S. Cl. CPC A47L 9/2873; A47L 9/2884; H02J 7/00712

(57) ABSTRACT

A method of operating a switch and an electric device employing the method. The method of operating the switch is according to an operation event occurring on a station side of a wireless vacuum cleaner, and includes activating a cleaner body according to the switch operation in a state in which a connection between a main processor of the cleaner body and a battery is blocked and charging from the station and the battery is stopped.

### CROSS-REFERENCE TO RELATED APPLICATION(S)

This application is a continuation application, claiming priority under § 365 (c), of International Application No. PCT/KR2023/004808, filed on Apr. 10, 2023, which is based on and claims the benefit of Korean patent application number 10-2022-062338 filed on May 20, 2022, and Korean patent application number 10-2023-013890, filed on Feb. 1, 2023, in the Korean Intellectual Property Office, the disclosures of which are incorporated by reference herein in their entireties.

### TECHNICAL FIELD

An embodiment of the present disclosure relates to a method of, when a device including a battery and a station device capable of charging the battery are coupled to each other, electrically activating either one of the devices through electronic switches included in the respective devices, and a device employing the method.

### BACKGROUND ART

A wireless vacuum cleaner is a type of cleaner that is used by charging a battery built into the vacuum cleaner itself without the need to connect a cord to an outlet. The wireless vacuum cleaner includes a suction motor that generates suction force, and may suck foreign substances such as dust along with air from a cleaner head (brush) through the suction force generated by the suction motor, and separate the sucked foreign substances from the air to collect dust.

Compared to wired vacuum cleaners, wireless vacuum cleaners are very convenient to use because there is no need to connect a power cord. Therefore, wireless vacuum cleaners have become popular. However, the uses of wireless vacuum cleaners have diversified depending on the user and environment conditions. In recent years, as wireless vacuum cleaners coupled to a station (dust discharger) that automatically empty dust in the dust bin attached to a main body of the wireless vacuum cleaner when docked with the station have also been used, use types, methods, and structures of vacuum cleaners have diversified.

In this case, a main body of the wireless vacuum cleaner is wirelessly driven through a battery. Because the vacuum cleaner body may provide various display functions in addition to cleaning functions, continuous battery charging is required. However, when frequent battery charging reduces battery life, and thus, it is necessary to charge the battery efficiently while performing the functions of the vacuum cleaner body smoothly.

### DISCLOSURE

### Technical Solution

An electric device may be configured to activate a first device, according to an embodiment of the present disclosure. The electric device includes a wireless vacuum cleaner device including a first device and a second device. The first device may include a cleaner body, a battery, a battery processor, a main processor, and a switch unit. The second device may include a station and a processor configured to detect an operation event and transmit a control signal corresponding to the operation event to the battery processor of the first device. The first device may include a switch unit to connect between the battery and a main processor, and the battery processor may be configured to operate the switch unit based on the control signal corresponding to the operation event, and cause the main processor activated by the battery according to the switch unit being operated.

According to an embodiment of the present disclosure, a wireless vacuum cleaner device configured to activate a wireless vacuum cleaner body is disclosed. The wireless vacuum cleaner device may be a wireless vacuum cleaner device including a wireless vacuum cleaner body and a station, the wireless vacuum cleaner body including a battery. The station includes a switch unit enabled to electrically connect the battery and the station, and a processor configured to detect an operation event and control such that the battery and the station are electrically connected to each other by operating the switch unit based on the operation event, and the wireless vacuum cleaner body includes a battery processor activated based on the switch unit of the station being turned on.

### DESCRIPTION OF DRAWINGS

FIG. 1 is a diagram of a wireless vacuum cleaner in which a station and a vacuum cleaner body are coupled to each other, according to an embodiment of the present disclosure.

FIG. 2 is a diagram illustrating information displayed on the vacuum cleaner body, according to an embodiment of the present disclosure.

FIG. 3A is a graph showing battery compensation charging of a wireless vacuum cleaner.

FIG. 3B is a graph showing battery compensation charging of a wireless vacuum cleaner.

FIG. 4A is a diagram for describing a station and a vacuum cleaner body according to an embodiment of the present disclosure.

FIG. 4B is a diagram for describing the vacuum cleaner body according to an embodiment of the present disclosure.

FIG. 5 is a block diagram of a wireless vacuum cleaner according to an embodiment of the present disclosure.

FIG. 6 is a diagram showing a communication connection structure between internal components of a vacuum cleaner body of a wireless vacuum cleaner according to an embodiment of the present disclosure.

FIG. 7 is an operation flowchart of a wireless vacuum cleaner according to an embodiment of the present disclosure.

FIG. 8A is a simplified diagram showing that a wirelessly driven device is activated according to an operation event, according to an embodiment of the present disclosure.

FIG. 8B is a block diagram of a wireless vacuum cleaner according to an embodiment of the present disclosure.

FIG. 9A is a detailed circuit diagram of a first switch unit and a second switch unit according to an embodiment of the present disclosure.

FIG. 9B is a detailed circuit diagram of a first switch unit and a second switch unit according to an embodiment of the present disclosure.

FIG. 10A is a sequence diagram showing that a vacuum cleaner body is activated, according to an embodiment of the present disclosure.

FIG. 10B is a sequence diagram showing that the vacuum cleaner body is activated in the absence of a first switch unit, according to an embodiment of the present disclosure.

FIG. 10C is a sequence diagram showing that the vacuum cleaner body is activated in the absence of a second switch unit, according to an embodiment of the present disclosure.

FIG. 11 is a flowchart showing that a vacuum cleaner body is activated, according to an embodiment of the present disclosure.

FIG. 12 is a sequence diagram for activating a vacuum cleaner body according to an operation event, according to an embodiment of the present disclosure.

FIG. 13 is a sequence diagram showing that a switching pattern is changed according to an operation event, according to an embodiment of the present disclosure.

FIG. 14 is a waveform diagram showing various turn-on patterns of the second switch unit according to an embodiment of the present disclosure.

FIG. 15 is a block diagram of a wireless vacuum cleaner according to an embodiment of the present disclosure.

FIG. 16 is a sequence diagram showing that a switching pattern is changed according to an operation event when connection C is present, according to an embodiment of the present disclosure.

FIG. 17 is a sequence diagram showing that the vacuum cleaner body is activated when the connection C is present, according to an embodiment of the present disclosure.

FIG. 18 is a diagram showing an automatic mobile vacuum cleaner according to an embodiment of the present disclosure.

FIG. 19 is a waveform diagram showing a compensation charging cycle of a wireless vacuum cleaner in standby mode according to an embodiment of the present disclosure.

FIG. 20 shows a waveform diagram for comparing before and after improvement of the compensation charging cycle of a wireless vacuum cleaner in standby mode according to an embodiment of the present disclosure.

### MODE FOR INVENTION

Terms used in the present disclosure are briefly described, and an embodiment of the present disclosure is described in detail.

For the terms used in the present disclosure, general terms that are currently widely used as much as possible while considering the function in an embodiment of the present disclosure, but this may vary depending on the intention or precedent of a person skilled in the art, the emergence of new technology, or the like. Also, some terms may be arbitrarily selected by the applicant, and in this case, the meaning of the selected terms is described in detail in the description of the corresponding embodiment of the present disclosure. Thus, the terms used herein have to be defined based on the meaning of the terms together with the description throughout the specification.

In the present disclosure, the expression “at least one of a, b, or c” refers to “a”, “b”, “c”, “a and b”, “a and c”, “b and c”, “all of a, b, and c”, or variations thereof.

Throughout the present disclosure, when a part “comprises” or “includes” a certain element, this means that it may further include other elements rather than excluding other elements, unless specifically described to the contrary. In addition, terms such as “ . . . unit” or “module” described in the present disclosure refer to a unit for processing at least one function or operation, and “ . . . unit” or “module” are implemented in hardware, software, or a combination of hardware and software.

Hereinafter, an embodiment of the present disclosure is described in detail with reference to the accompanying drawings such that one of ordinary skill in the art may easily implement an embodiment of the present disclosure. However, an embodiment of the present disclosure may be implemented in various different forms and is not limited to the embodiments described herein. Also, in the drawings, parts irrelevant to the description are omitted in order to clearly describe an embodiment of the present disclosure, and like reference numerals designate like elements throughout the present disclosure.

According to an embodiment of the present disclosure, a method of waking up a vacuum cleaner body and a battery according to an wake-up event occurring in a station while preventing power loss where electrical connection between a control unit of the vacuum cleaner body and the station responsible for battery and charging is released so as to minimize power loss of the wireless vacuum cleaner, and a wireless vacuum cleaner employing the method are provided.

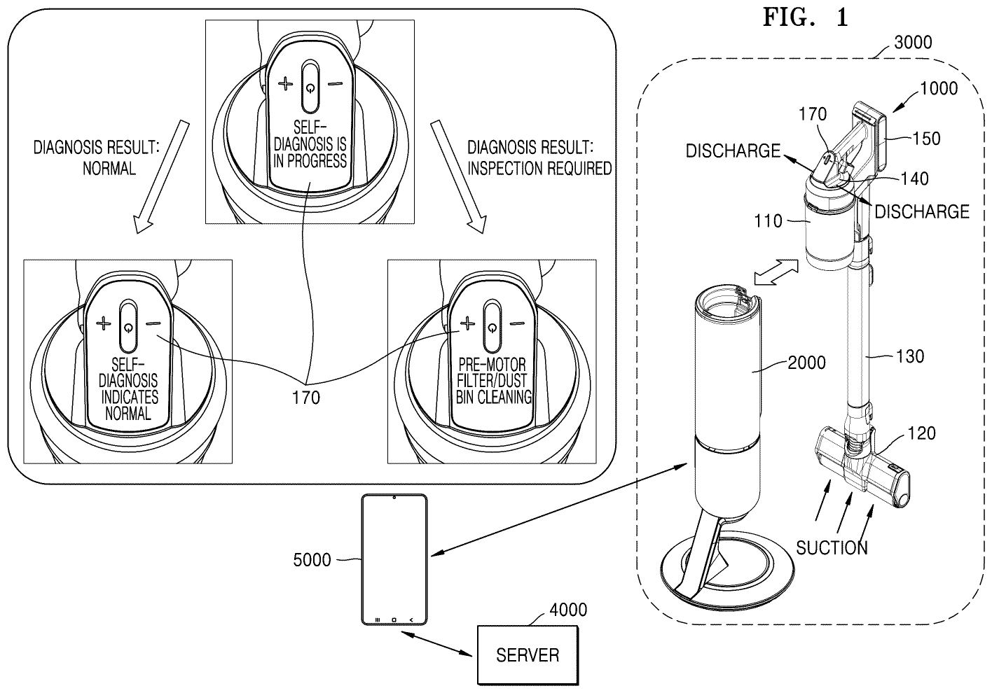

FIG. 1 is a diagram of a wireless vacuum cleaner device in which a station and a cleaner body are coupled to each other, according to an embodiment of the present disclosure.

Referring to FIG. 1, a wireless vacuum cleaner 3000 in which a station 2000 and a vacuum cleaner body 1000 are coupled to each other, according to an embodiment of the present disclosure, may be a stick-type vacuum cleaner including the cleaner body 1000, a brush device 120, and an extension tube 130. The wireless vacuum cleaner 3000 according to an embodiment of the present disclosure may be a hand-type vacuum cleaner including the cleaner body 1000 and the brush device 120. The wireless vacuum cleaner 3000 according to an embodiment of the present disclosure may be a wireless vacuum cleaner including the cleaner body 1000, the brush device 120, the extension tube 130, and the station 2000. The wireless vacuum cleaner 3000 according to an embodiment of the present disclosure may be selectively used as one from among a hand-type vacuum cleaner, an automatic mobile vacuum cleaner, and a stick-type vacuum cleaner. The hand-type vacuum cleaner, the automatic mobile vacuum cleaner, and the stick-type vacuum cleaner according to an embodiment of the present disclosure may be wireless vacuum cleaners.

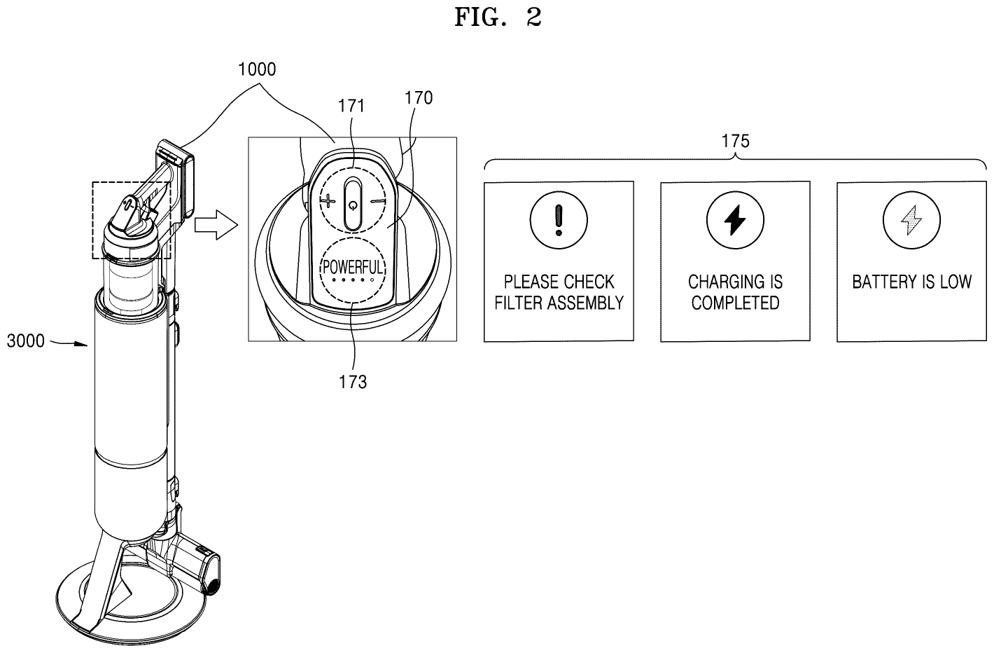

The cleaner body 1000 according to an embodiment of the present disclosure may be a portion that may be held or moved by the user when cleaning. The cleaner body 1000 may include a dust bin (or dust collection bin) 110 that accommodates foreign substances sucked from a surface being cleaned (e.g., floor (e.g., floor, carpet, mat, etc.), bedding, sofa, etc.). The cleaner body 1000 may include a filter unit 140 that filters ultrafine dust or the like not filtered in the dust bin 110 and discharges air from which the ultrafine dust is removed to the outside of the cleaner body 1000. The cleaner body 1000 may include a pressure sensor 160 used to detect a value of pressure (hereinafter, referred to as “dust suction flow path pressure”) inside a dust suction flow path. The dust suction flow path of the cleaner body 1000 may represent a section from a position at which suction of air including foreign substances starts to a position at which air from which the foreign substances are removed is discharged. For example, the dust suction flow path of the cleaner body 1000 may represent a section from a suction port 129 of the brush device 120 to the filter unit 140 of the cleaner body 1000, but is not limited thereto. The cleaner body 1000 may include a battery 150 for supplying power to the cleaner body 1000. The cleaner body 1000 may include a user interface 170 for receiving a user input and outputting information about self-diagnosis results of the wireless vacuum cleaner 3000. As shown in FIG. 1, various pieces of information may be displayed on the user interface 170. For example, on the user interface 170, when a processor of the cleaner body 1000 is performing self-diagnosis, a message “Self-diagnosis is in progress” may be displayed, and when necessary action is required as a result of the self-diagnosis, for example, a message such as “Clean pre-motor filter/dust bin” may be displayed. Displaying information through the user interface 170 as described above may cause the cleaner body 1000 to depend on power supplied from the battery 150, and thus, it is necessary to charge the battery 150 of the cleaner body 1000 by a charging circuit 2010 of the station 2000. The information displayed on the cleaner body 1000 is discussed in more detail with reference to FIG. 2.

FIG. 2 is a diagram illustrating information displayed on the vacuum cleaner body, according to an embodiment of the present disclosure.

Referring to FIG. 2, the cleaner body 1000 of the wireless vacuum cleaner 3000 may include the user interface 170, and the user interface 170 may include an input interface 171 for inputting a command to the wireless vacuum cleaner 3000, and an output interface 173 through which the wireless vacuum cleaner 3000 displays information 175 to a user. The input interface 171 may be a user input interface capable of touch recognition.

The output interface 173 may be a liquid crystal display (LCD) or light emitting diode (LED) display, but is not limited thereto. Various information that may show a state of the wireless vacuum cleaner 3000 to the user may be displayed on the output interface 173. Referring to FIG. 2, information such as “Please check the filter assembly”, “Charging is complete”, or “The battery is low” may be displayed on the output interface 173.

The output interface 173 of the cleaner body 1000 provides information about a state of the wireless vacuum cleaner 3000, making it convenient for the user to obtain information, but this continuously consumes power within the wireless vacuum cleaner 3000. As power within the wireless vacuum cleaner 3000 is consumed, the battery 150 is discharged, and thus, the station 2000 must continuously compensate and charge the battery 150 according to a certain cycle. The output interface 173 may provide information of the wireless vacuum cleaner 3000, such as an operating state, a charging amount display, and whether or not the cleaner is charged. In particular, even when a screen of the output interface 173 is turned off after the cleaner body 1000 is mounted on the station 2000 and charging is completed, continuous power consumption from a related circuit (control unit) including an output driver for driving the output interface 173, a detection sensor that detects when the cleaner body 1000 is docked to the station 2000, and loads is unavoidable. Here, “docking” may include not only that the station 2000 and the cleaner body 1000 are electrically coupled but also that the station 2000 and the cleaner body 1000 are in mechanical close contact with each other. That the station 2000 and the cleaner body 1000 are “docked” means that the cleaner body 1000 is mounted on the station 2000. However, the present disclosure is not limited thereto. It may include cases in which the station 2000 is mounted on or coupled to the cleaner body 1000 thereunder, and the station 2000 and the cleaner body 1000 are docked from each other's sides.

The reason why the battery 150 provided in the cleaner body 1000 cannot completely cut off power of a main circuit including the user interface 170 of the cleaner body 1000 is that there is a linked operation between the cleaner body 1000 and the station 2000. In other words, in order to perform the linked operation between the cleaner body 1000 and the station 2000, power must be continuously supplied from the station 2000 to the battery 150 of the cleaner body 1000.

The station 2000 may perform an automatic/manual dust emptying operation and communicate with the cleaner body 1000 through communication connections (WiFi, Bluetooth Low Energy (BLE). In addition, continuous power consumption occurs in the cleaner body 1000 due to performance of communication operations between user terminal 5000<->station 2000<->cleaner body 1000, performance of other linked operations between the station 2000 and the cleaner body 1000, or the like. Even when the cleaner body 1000 is mounted on or docked to the station 2000, and charging of the battery 150 is completed, power consumption continuously occurs in related circuits including a driver (LCD driver) that is a driving circuit of the output interface 173, a detection sensor, and a communication unit. Accordingly, power of the battery 150 included in the cleaner body 1000 is continuously supplied to a circuit of the cleaner body 1000 (e.g., main processor), so that the power of the battery 150 of the cleaner body 1000 is consumed. Ultimately, this power consumption of the battery 150 leads to frequent batter charging and compensation charging, which affects the lifespan of the battery 150 and may cause a situation where the battery 150 needs to be replaced frequently.

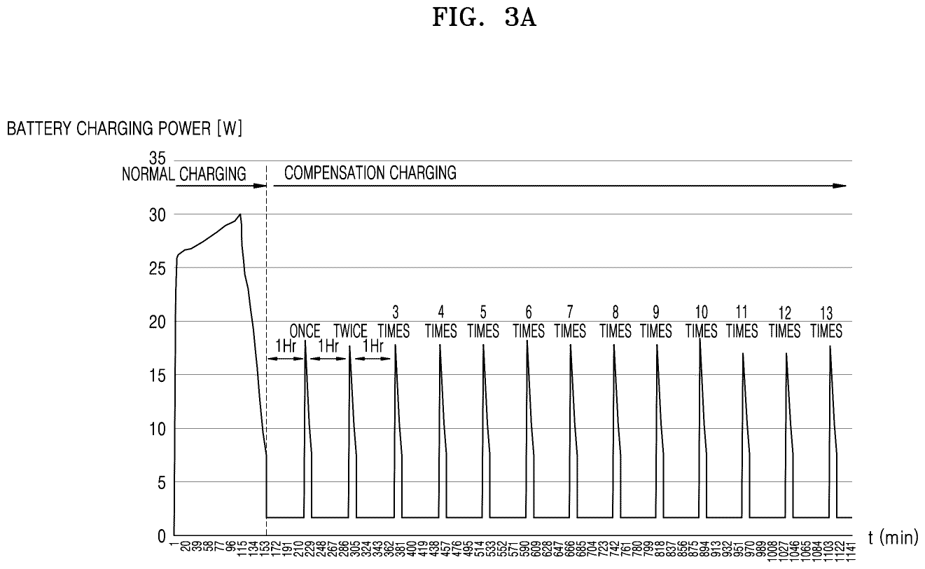

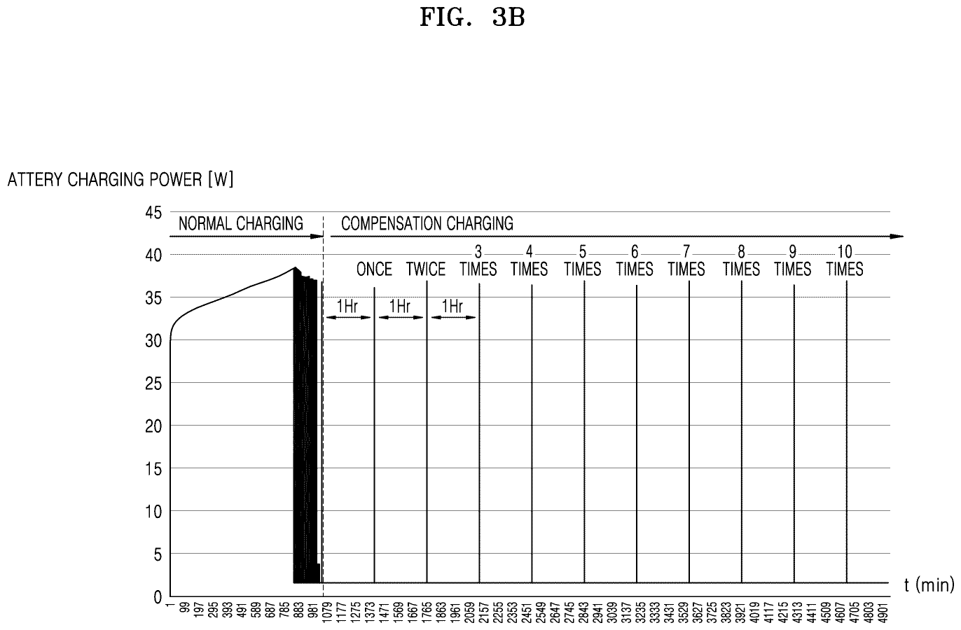

FIG. 3A is a graph showing battery compensation charging of a wireless vacuum cleaner.

Referring to FIG. 3A, when the cleaner body 1000 of the wireless vacuum cleaner 3000 is coupled to the station 2000, a normal charging period occurs in which the battery 150 of the cleaner body 1000 is charged. In FIG. 3A, a period in which the battery 150 is charged occurs for approximately 2 hours and 30 minutes, and a length of the normal period may vary depending on a capacity of the battery 150 or a magnitude of charging power. Even after the battery 150 in the cleaner body 1000 is normally fully charged during the normal charging period, the battery 150 is consumed due to the power consumption of related circuits such as the control unit circuit of the cleaner body 1000 and the user interface 170. The reason why the battery 150 provided in the cleaner body 1000 cannot completely cut off power of a main circuit including the user interface 170 of the cleaner body 1000 is that there is a linked operation between the cleaner body 1000 and the station 2000. In other words, in order to perform the linked operation between the cleaner body 1000 and the station 2000, power must be continuously supplied from the station 2000 to the cleaner body 1000, and also, the battery 150 of the cleaner body 1000 must continuously supply power to the cleaner body 1000. For this reason, as shown in FIG. 3A, a compensation charging period of the battery 150 continuous even after the normal charging period. Referring to FIG. 3A, it can be seen that due to the continuous power consumption of the cleaner body 1000, compensation charging is required once every approximately 1 hour even after normal charging of the battery 150. However, this is only an example, and the compensation charging cycle may vary depending on settings of the manufacturer.

Here, it should be understood that “coupling” between the cleaner body 1000 of the wireless vacuum cleaner 3000 and the station 2000 includes any coupling forms that enable electrical and/or mechanical connection between the cleaner body 1000 and the station 2000. In other words, it should be understood that the case includes any forms such as coupling in which the cleaner body 1000 is mounted on the station 2000, and electrical coupling of the cleaner body 1000 at a side or bottom of the station 2000.

FIG. 3B is a graph showing battery compensation charging of a wireless vacuum cleaner.

Referring to FIG. 3B, battery compensation charging of a wireless vacuum cleaner of a different type from the wireless vacuum cleaner 3000 of FIG. 3A is shown. However, it can be seen that periodic compensation charging is also performed on the wireless vacuum cleaner 3000 according to FIG. 3B at intervals of about 1 hour due to continuous power consumption within the cleaner body 1000 even after the battery 150 of the cleaner body 1000 is fully charged.

Because the wireless-type wireless vacuum cleaner 3000 operates with the battery 150 rather than a power line, battery efficiency and power efficiency are important. Thus, it is necessary to minimize power loss occurring in the battery 150. When the efficiency of the battery 150 is low, an operating time of the battery 150 is shortened, and this low efficiency leads to frequent charging and compensation charging of the battery 150, affecting battery life. The shortened battery life leads to frequent battery replacement cycles. In addition, the wireless vacuum cleaner 3000 spends most of a time thereof stationary for storage rather than being in use (cleaning). Accordingly, when the power consumption that occurs when the wireless vacuum cleaner 3000 is not in use (cleaning) may be minimized, overall battery efficiency may be improved and potential failure factors of components may also be eliminated. Therefore, there is a need to improve overall efficiency by minimizing the power consumption that occurs when the wireless vacuum cleaner 3000 is not in use (cleaning).

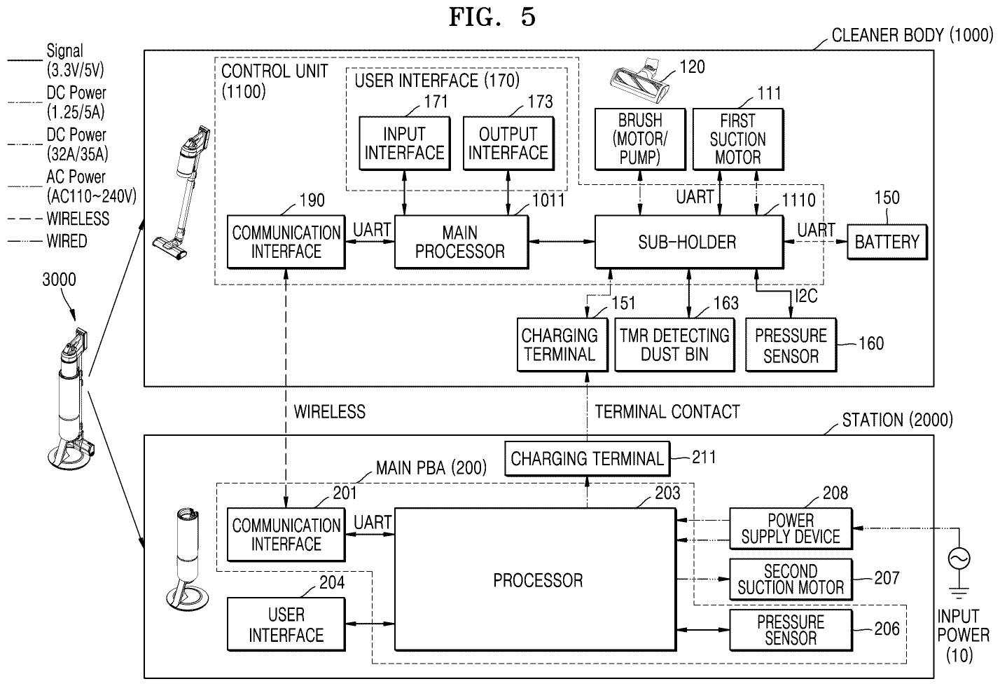

Remaining configurations of the wireless vacuum cleaner 3000 are described below with reference to FIG. 1 again. In the cleaner body 1000 according to an embodiment of the present disclosure, a pressure sensor may be mounted on a part of a suction duct, but is not limited thereto. For example, the cleaner body 1000 may include more or fewer elements than the elements shown in FIG. 1. A detailed configuration of the cleaner body 1000 is described in greater detail with reference to FIG. 5 described below.

The brush device 120 according to an embodiment of the present disclosure is a device that is in close contact with a surface to be cleaned and may suck air and foreign substances from the surface to be cleaned. The brush device 120 may also be represented as a vacuum cleaner head. The brush device 120 may be rotatably coupled to the extension tube 130. The brush device 120 may include a motor, a motor controller, and a drum to which a rotating brush is attached, but is not limited thereto. For example, the brush device 120 may further include at least one processor for controlling communication with the cleaner body 1000. There may be various types of brush device 120.

The extension tube 130 may be formed of a pipe or flexible hose with a certain rigidity. Accordingly, the extension tube 130 may be referred to as a pipe. The extension tube 130 may transfer, to the brush device 120, a suction force generated through a suction motor 111 of the cleaner body 1000 and move air and foreign substances sucked through the brush device 120 to the cleaner body 1000. The extension tube 130 may be a vacuum state according to an operation of the suction motor 111. The extension tube 130 may be separably connected to the brush device 120. The extension tube 130 may be formed in a plurality of stages between the cleaner body 1000 and the brush device 120. Two or more extension tubes 130 may be provided.

The cleaner body 1000, the brush device 120, and the extension tube 130 included in the wireless vacuum cleaner 3000 according to an embodiment of the present disclosure may include a power line for transferring power supplied from the battery 150 to the cleaner body 1000 and the brush device 120. The wireless vacuum cleaner 3000 may supply power to the cleaner body 1000 and the brush device 120 by using a power line.

The cleaner body 1000 according to an embodiment of the present disclosure may detect whether the brush device 120 is attached or detached, identify a type of the brush device 120, and adaptively control an operation (e.g., rotations per minute (RPM) of the rotating brush (or drum), RPM of a motor mounted on the brush) of the brush device 120 according to a use environment state (e.g., hard floor, carpet, mat, corner, lifted state from the surface to be cleaned, or no load state, etc.) of the brush device 120.

In order to determine whether the brush device 120 is not affected by the surface to be cleaned based on a flow path pressure value, the cleaner body 1000 may have a reference value for a pressure value of a dust suction flow path related to the state in which the brush device 120 is not affected by the surface to be cleaned. The reference value for the dust suction flow path pressure value may be stored in a memory 180 and obtained and used by at least one main processor 1011.

Referring to FIG. 1, a communication system may include the wireless vacuum cleaner 3000, the station 2000, and a server 4000. However, not all of the elements shown in FIG. 1 are essential. The communication system may be implemented with more elements than those shown in FIG. 1, or may be implemented with fewer elements. For example, the communication system may be implemented to include the cleaner body 1000 and the station 2000, excluding the server 4000. In addition, the communication system may be implemented to further include the user terminal 5000. The user terminal 5000 may be a terminal registered to the server 4000 with a same account as the wireless vacuum cleaner 3000 or the station 2000. The user terminal 5000 may include, for example, mobile terminals (e.g., smartphones, wearable devices, or tablets), home appliances including displays (e.g., refrigerators, televisions (TVs), computers, or the like), or the like, but is not limited thereto.

The wireless vacuum cleaner 3000 may refer to a wireless vacuum cleaner that has a built-in rechargeable battery 150 and does not need to connect a power cord to an outlet during cleaning, but is not limited thereto. The wireless vacuum cleaner 3000 may include a robot cleaner that automatically performs cleaning while the cleaner body 1000 automatically moves the surface being cleaned. The user may move the cleaner body 1000 back and forth by using a handle mounted on the cleaner body 1000 so that the brush device (cleaner head) 120 sucks dust or foreign substances (garbage) from the surface being cleaned. The wireless vacuum cleaner 3000 may include a communication interface for performing communication with the station 2000. For example, the wireless vacuum cleaner 3000 may transmit and receive data with the station 2000 through a wireless personal area network (WPAN).

The station 2000 may be a device for discharging dust collected in the cleaner body 1000, charging the battery, or mounting. The station 2000 may be represented as a clean station. According to an embodiment of the present disclosure, the station 2000 may perform communication with the cleaner body 1000 or the server 4000 through a network. For example, the station 2000 may transmit and receive data to and from the cleaner body 1000 through the WPAN that does not pass through an access point (AP). The station 2000 may transmit or receive data to or from the server 4000 through an access relay (AP) that connects a local area network (LAN) to which the station 2000 is connected to a wide area network (WAN) to which the station 2000 is connected. For example, the station 2000 may be connected to the cleaner body 1000 through BLE communication and may be connected to the server 4000 through Wi-Fi (IEEE 802.11) communication.

Accordingly, when a Wi-Fi communication module is not provided in the cleaner body 1000, the station 2000 may serve to relay communication between the cleaner body 1000 and the server 4000. For example, the station 2000 may upload data received from the cleaner body 1000 to the server 4000. In addition, the station 2000 may transfer the data received from the server 4000 to the cleaner body 1000.

The server 4000 may be a device for managing the station 2000 and the cleaner body 1000. For example, the server 4000 may be a home appliance management server. The server 4000 may manage user account information and information about a home appliance connected to the user account. For example, the user may access the server 4000 through the user terminal 5000 and generate a user account. The user account may be identified by an ID and password set by the user. The server 4000 may register the station 2000 and the cleaner body 1000 to the user account according to a set procedure. For example, the server 4000 may connect identification information (e.g., serial number or MAC address) of the station 2000 and identification information of the cleaner body 1000 to the user account and register the station 2000 and the cleaner body 1000. When the station 2000 and the cleaner body 1000 are registered in the server 4000, the server 4000 may periodically receive state information of the station 2000 or state information of the cleaner body 1000 from the station 2000, thereby managing a state of the station 2000 or a state of the cleaner body 1000.

Meanwhile, when software related to control of the station 2000 or software related to control of the cleaner body 1000 is updated (hereinafter also referred to as “upgraded”), a new version of software may be registered in a memory of the server 4000. When a download request for a new version of software is received from the station 2000, the new version of software may be transmitted to the station 2000. Here, the software may also be represented as firmware.

When the new version of software is software related to control of the station 2000, the station 2000 may download the new version of software to update software pre-installed in the station 2000. According to an embodiment of the present disclosure, the software related to control of the station 2000 may include an algorithm related to a dust discharge operation (cycle) (e.g., an algorithm for controlling an intensity of suction force of a second suction motor of the station 2000), an algorithm related to an operation of the output interface (e.g., a display including an LCD or an acoustic output unit including a speaker), an algorithm for diagnosing the state of the station 2000, but is not limited thereto.

In addition, when the new version of software is the software related to control of the cleaner body 1000, the station 2000 may transmit the new version of software to the wireless vacuum cleaner 3000 to update the software pre-installed in the wireless vacuum cleaner 3000. According to an embodiment of the present disclosure, the software related to control of the cleaner body 1000 may include an artificial intelligence (AI) model trained to infer a use environment state of the brush device 120, a control algorithm related to an operating mode of the cleaner body 1000 (e.g., an algorithm for controlling an intensity of the suction force of the suction motor of the cleaner body, or an algorithm for controlling a number of rotation per minute (hereinafter, referred to as “drum RPM”) of a rotating brush of the brush device 120), an algorithm for diagnosing filter blockage, dust suction flow path blockage, overload or incorrect assembly of the brush device 120, or the like, but is not limited thereto.

Accordingly, according to an embodiment of the present disclosure, even though the cleaner body 1000 does not have a separate communication module (e.g., Wi-Fi communication module) that may directly communicate with the server 4000, a new version of software registered in the server 4000 may be downloaded through the station 2000 connected to the server 4000, to conveniently update pre-installed software in an over the air (OTA) manner. OTA refers a technology of wirelessly updating software (firmware) by using Wi-Fi communication without connecting to a computer. OTA may also be represented as over the network (OTN).

In addition, according to an embodiment of the present disclosure, the user may update a control algorithm or learning model of the existing wireless vacuum cleaner 3000 to a latest version without purchasing a new wireless vacuum cleaner 3000, thereby improving user convenience of the wireless vacuum cleaner 3000.

The station 2000 may download, to the wireless vacuum cleaner 3000, the new version of software related to control of the wireless vacuum cleaner 3000 so that the software of the wireless vacuum cleaner 3000 may be updated.

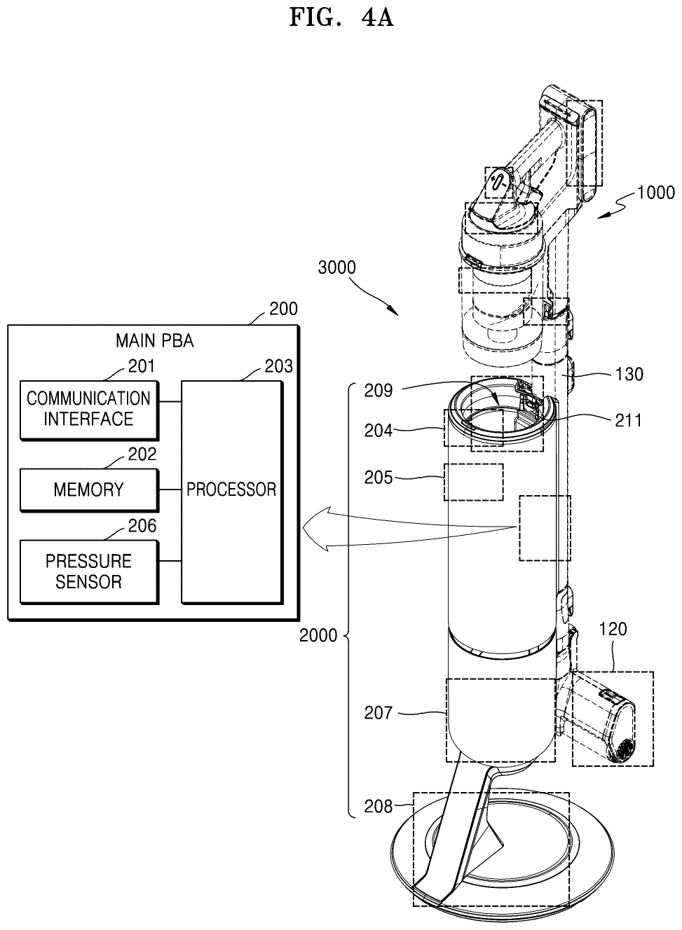

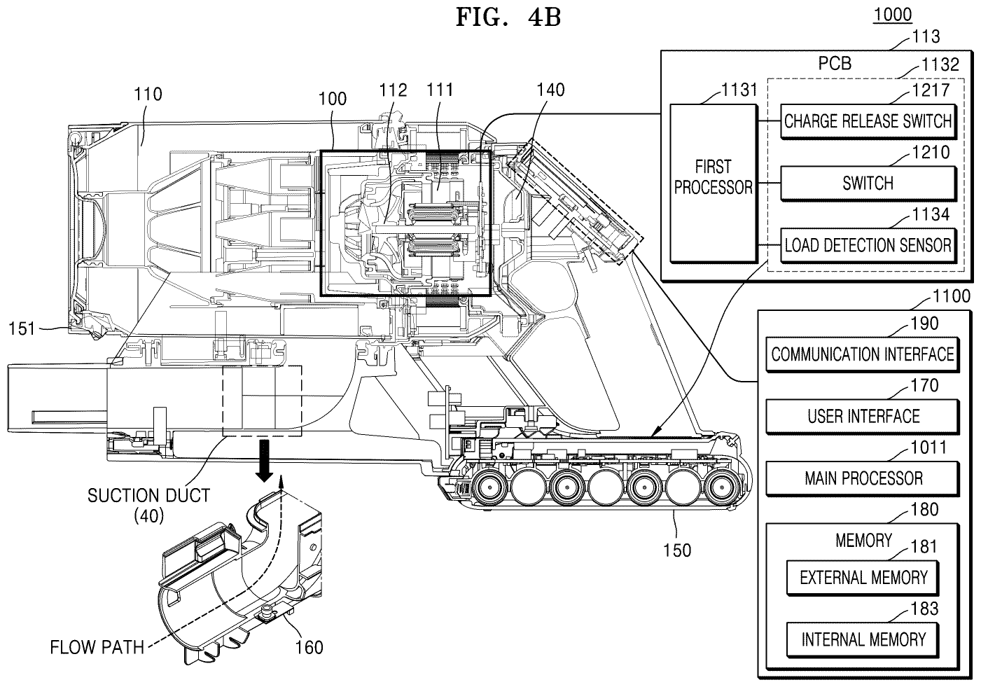

FIG. 4A is a diagram for describing a station and a cleaner body according to an embodiment of the present disclosure.

Referring to FIG. 4A, a main printed board assembled (PBA) 200 of the station 2000, according to an embodiment of the present disclosure, may include a communication interface 201, a memory 202, a pressure sensor 206, and at least one processor 203. The at least one processor 203 may be referred to as “station processor”. In addition, the station 2000 may further include a user interface 204, a wired connector 205, a second suction motor 207, a power supply device 208, a flow path 209 connected to the dust bin of the cleaner body 1000, a charging terminal 211 for charging the battery 150 of the cleaner body 1000, a dust collector coupling portion, a collection portion 212, a filter portion, or the like. The second suction motor 207 is referred to as the second suction motor 207 to distinguish the second suction motor 207 from the first suction motor 111 of the cleaner body 1000. Each of the elements is discussed below.

The station 2000 may include the communication interface 201 for performing communication with external devices. For example, the station 2000 may communicate with the cleaner body 1000 of the wireless vacuum cleaner 3000 or the server 4000 through the communication interface 201. In this case, the communication interface 201 may communicate with the server 4000 through a first communication scheme (e.g., Wi-Fi communication scheme) and communicate with the cleaner body 1000 through a second communication scheme (e.g., BLE communication scheme).

The communication interface 201 may include a short-range wireless communication interface, a long-distance communication interface, or the like. The short-range wireless communication interface may include a Bluetooth communication interface, a BLE communication interface, a near field communication (NFC) interface, a Wi-Fi local area network (WLAN) communication interface, a Zigbee communication interface, an infrared data association (IrDA) communication interface, a Wi-Fi Direct (WFD) communication interface, a ultra wideband (UWB) communication interface, an Ant+ communication interface, or the like, but is not limited thereto. The long-distance communication interface may be used by the station 2000 to remotely communicate with the server 4000. The long-distance communication interface may include the Internet, a computer network (e.g., LAN or WAN), and a mobile communication interface. The mobile communication interface may include a 3G module, a 4G module, a 5G module, a long-term evolution (LTE) module, a narrowband Internet-of-Things (NB-IoT) module, an LTE Machine Type Communication (LTE-M) module, or the like, but is not limited thereto.

The communication interface 201 may transmit data to the at least one processor 203 through a universal asynchronous receiver/transmitter (UART), which is asynchronous communication, but the communication scheme is not limited thereto.

The memory 202 of the station 2000 may store programs (e.g., one or more instructions) for the at least one processor 203 to generally control operations of the wireless vacuum cleaner 3000 and/or the station 2000, and may store input/output data. For example, the memory 202 of the station 2000 may include software related to control of the station 2000, state data of the second suction motor 207, measurement values of the pressure sensor 206, error occurrence data (failure history data), type of an operation event, battery charging-related information—charging interval, recent compensation charging time point data, or charging level of the battery 150 at the time of recent compensation charging—or the like, but is not limited thereto. The memory 202 of the station 2000 may store data received from the cleaner body 1000. For example, the memory 202 may store product information (e.g., identification information, model information, etc.) of the wireless vacuum cleaner 3000 mounted on the station 2000, version information of software installed in the wireless vacuum cleaner 3000, error occurrence data (failure history data) of the wireless vacuum cleaner 3000, charging-related information of the battery 150, or the like.

The memory 202 may include a storage medium of at least one type from among a flash memory type, a hard disk type, a multimedia card micro type, a card type (e.g., secure digital (SD) or extreme digital (XD) memory), random access memory (RAM), static RAM (SRAM), read-only memory (ROM), electrically erasable programmable ROM (EEPROM), programmable read-only memory (PROM), magnetic memory, magnetic disk, or optical disk. Programs stored in the memory 202 may be classified into a plurality of modules according to functions thereof.

The station 2000 may include the main PBA 200, and the main PBA 200 may include the at least one processor 203. The station 2000 may include one processor or may include a plurality of processors. The at least one processor 203 according to the present disclosure may include at least one of a central processing unit (CPU), a graphics processing unit (GPU), an accelerated processing unit (APU), a many integrated core (MIC), a digital signal processor (DSP), or a neural processing unit (NPU). The at least one processor 203 may be implemented in the form of an integrated system-on-chip (SoC) including one or more electronic components. Each of the at least one processor 203 may also be implemented as separate hardware (H/W). The at least one processor 203 may be represented as a microprocessor controller (MICOM), a microprocessor unit (MPU), a micro controller unit (MCU).

The at least one processor 203 according to the present disclosure may be implemented as a single core processor or may be implemented as a multicore processor.

In an embodiment of the present disclosure, the at least one processor 203 may control a second switch unit to be operated based on an operation event, the second switch unit connecting the station 2000 to the battery 150 and/or battery processor 1551 of the cleaner body 1000. In an embodiment of the present disclosure, the at least one processor 203 may transmit an operation event (or a control signal corresponding to the operation event) to the battery processor 1551. The battery processor 1551 may activate the main processor 1011 of the cleaner body 1000 based on the operation event (or the control signal corresponding to the operation event). In an embodiment of the present disclosure, activating the main processor 1011 may be performed by the battery processor 1551 turning on the first switch unit that connects the battery 150 to the main processor 1011.

The operation event may be at least one of an event in which the user pushes a user input button, which is the user interface 204, an event in which the at least one processor 203 of the station 2000 receives a control signal from the server 4000 or the user terminal 5000 of the user through communication, an event in which the at least one processor 203 executes the control signal according to a program stored in the memory 202 of the station 2000, or an event in which the cleaner body 1000 is electrically coupled to the station 2000. In an embodiment of the present disclosure, the operation event may be an event for emptying the dust bin 110 of the cleaner body 1000. In an embodiment of the present disclosure, a control signal for triggering an event according to a program stored in the memory 202 of the station 2000 may be periodically executed and generated.

In an embodiment of the present disclosure, the wireless vacuum cleaner 3000 may be a robot cleaner, the cleaner body 1000 may be an automatic mobile cleaner body, and the event in which the cleaner body 1000 is electrically coupled to the station 2000 may be an event in which the automatic mobile cleaner completes a certain cleaning operation and is docked to the station 2000 and electrically coupled to the station 2000. In this case, an operation event may occur on the station 2000 side by an operation in which the automatic mobile cleaner body completes a cleaning operation and is coupled to the station 2000 and the station 2000 automatically moves dust collected in the automatic mobile cleaner body to the station 2000 side.

In an embodiment of the present disclosure, when the at least one processor 203 detects an event in which a user input button is pressed according to an operation event of the user pushing the corresponding input button to empty the dust bin 110, the at least one processor 203 may turn on the second switch unit, as the second switch unit is turned on, the battery 150 and the battery processor 1551 of the cleaner body 1000 may be activated, and the activated battery processor 1551 may turn on the first switch unit to activate the main processor 1011 of the cleaner body 1000. In an embodiment of the present disclosure, in the absence of the second switch unit, when the at least one processor 203 detects an event in which a user input button is pressed according to an operation event in which the user pushes the corresponding input button to empty the dust bin 110 of the cleaner body 1000, the at least one processor 203 may transmit a control signal corresponding to the operation event to the battery processor 1551 of the cleaner body 1000, and the battery processor 1551 that receives the control signal corresponding to the operation event may turn on, based on the received control signal, the first switch unit connecting the battery 150 to the main processor 1011 and activate the main processor 1011 of the cleaner body 1000. In an embodiment of the present disclosure, in a case in which the battery 150 and the main processor 1011 are always electrically connected to each other without the first switch unit, when an operation event occurs in the station 2000, the at least one processor 203 may detect the operation event, and turn on, based on the detected operation event, the second switch connecting the battery 150 to the station 2000 and activate the cleaner body 1000.

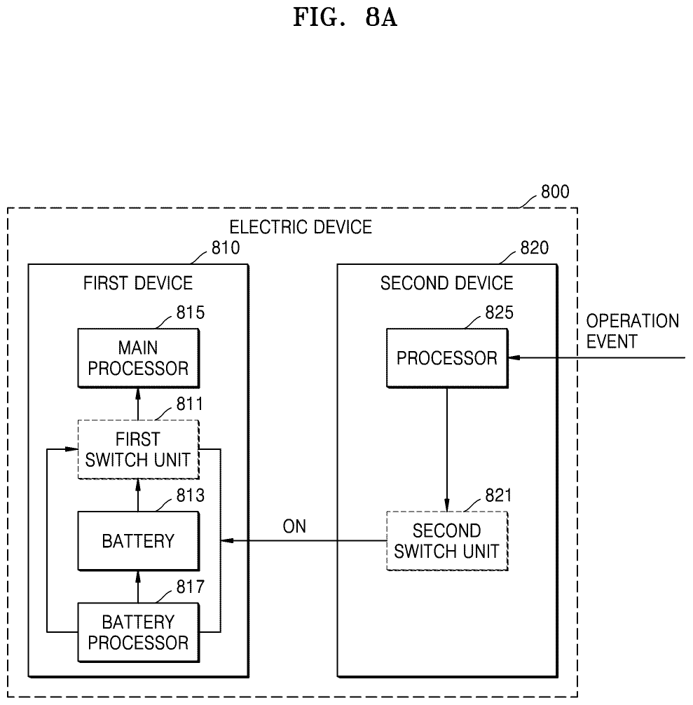

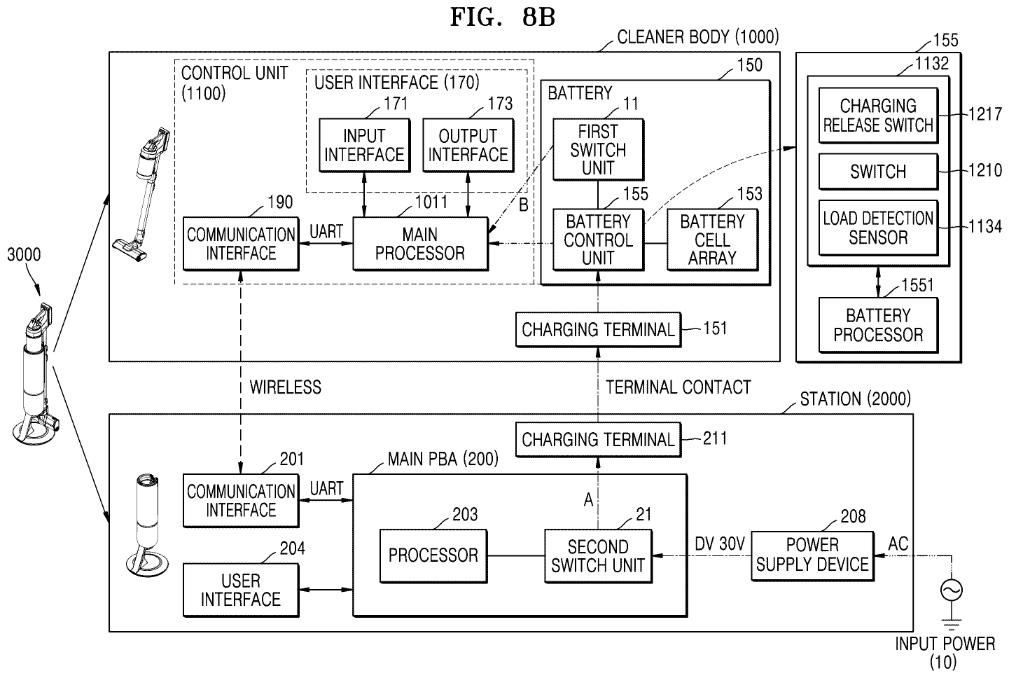

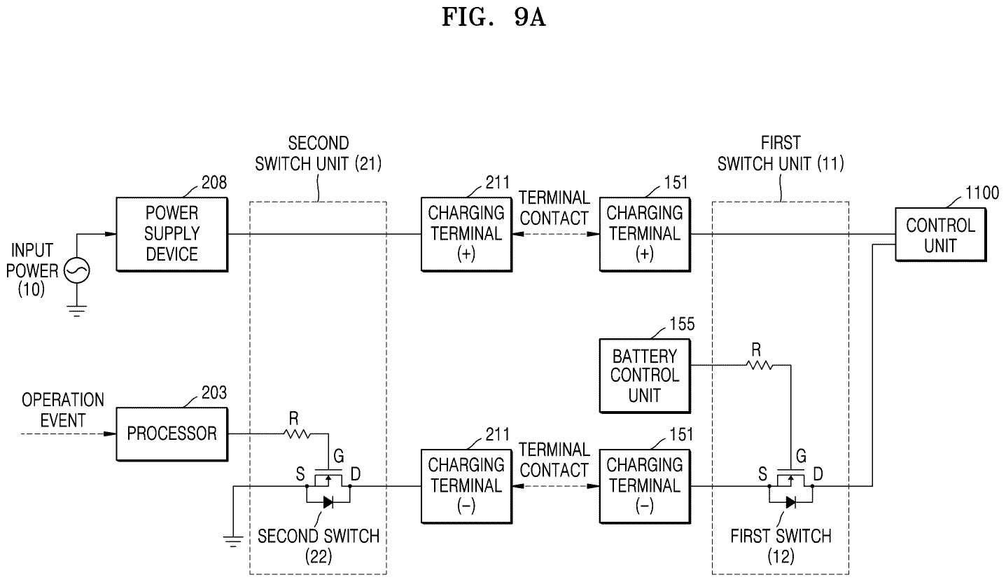

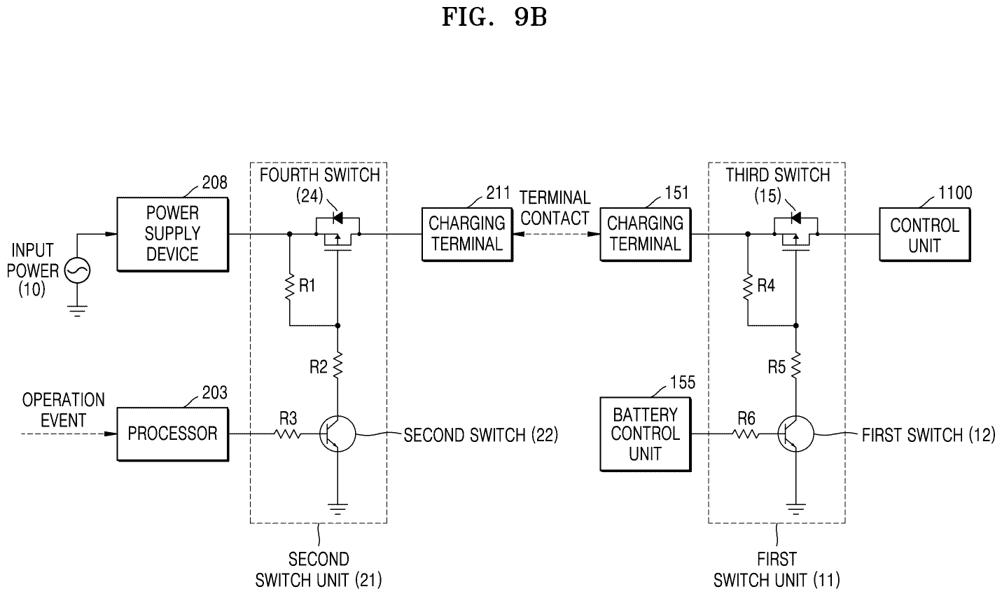

The linked operation described above is described in greater detail with reference to FIGS. 8A and 9A.

When the first switch of the cleaner body 1000 is turned on, the battery processor 1551 of the cleaner body 1000 and the main processor 1011 of the cleaner body 1000 may be activated. In other words, the main processor 1011 of the cleaner body 1000 may be activated by turning on the second switch unit and activating the battery processor 1551 of the cleaner body 1000 according to the second switch unit so that the battery processor 1551 operates the first switch unit.

The user interface 204 of the station 2000 may include an input interface and an output interface. The input interface may include a dust discharge button, a mode selection button, or the like that may be input by the user. The output interface may include an LED, an LCD, a touch screen, or the like, but is not limited thereto. The output interface may display a charging amount of the battery 150 of the cleaner body 1000, software update progress information, operation event information, or the like, but is not limited thereto.

The station 2000 may include the wired connector 205. The wired connector 205 may include a terminal for connecting a computing device of a system administrator (e.g., service technician).

The pressure sensor 206 of the station 2000 may be a sensor for measuring pressure of a flow path, which connects the station 2000 to the cleaner body 1000. The pressure sensor 206 may measure a pressure value before dust is discharged or a pressure value after dust is discharged. The pressure sensor 206 may transfer a pressure measurement value to the at least one processor 203 through inter-integrated communication (I2C), but is not limited thereto, and may transfer a pressure measurement value through communication of another type.

The second suction motor 207 of the station 2000 may be a device that generates a suction force for discharging, from the cleaner body 1000, foreign substances collected in the dust bin 110 of the cleaner body 1000. The second suction motor 207 may rotate a suction fan that moves air. The suction fan may include an impeller.

The power supply device 208 may include a switching mode power supply (SMPS) that receives indirect current input power 10 from a power source and converts the received indirect current input power 10 into direct current power. When the cleaner body 1000 is coupled to the station 2000, the direct current power generated by the power supply device 208 may be supplied to the battery 150 of the cleaner body 1000 through the charging terminal 211 so that the battery 150 may be charged.

The charging terminal 211 may be connected to a charging terminal 151 of the cleaner body 1000 and used to charge the battery 150 included in the cleaner body 1000. The charging terminal 211 may be connected to an SMPS of the power supply device 208 and may provide electrical connection for charging the battery 150 with direct current power output from the SMPS.

The dust collector coupling portion may be provided such that the dust bin 110 of the cleaner body 1000 is coupled to the station 2000. When the dust bin 110 is mounted on the dust collector coupling portion, coupling of the cleaner body 1000 and the station 2000 may be completed. The dust collector coupling portion may include a docking detection sensor for detecting coupling or docking of the cleaner body 1000. The docking detection sensor may be a tunnel magneto-resistance (TMR) sensor, but is not limited thereto. The TMR sensor may detect a magnetic material attached to the dust collector to sense whether the cleaner body 1000 is docked. The station 2000 may include a step motor that applies pressure to one side of a dust bin door 114 to open the dust bin door 114 when docked to the station 2000.

The collection portion 212 may be a space in which foreign substances discharged from the dust bin of the cleaner body 1000 may be collected. The collection portion 212 may include a dust bag in which foreign substances discharged from the dust bin are collected. The dust bag may be formed of a material that transmits air and does not transmit foreign substances, and may collect foreign substances flowing from the dust bin into the collection portion 212. The dust bag may be provided to be separable from the collection portion 212. The station 2000 may include an ultraviolet radiation unit that radiates ultraviolet rays to the collection portion 212. The ultraviolet radiation unit may include a plurality of ultraviolet lamps.

The filter unit 140 may filter out ultrafine dust or the like that is not collected in a collection bin. The filter unit 140 may include an outlet through which air passing through a filter is discharged to the outside of the station 2000. The filter unit 140 may include a motor filter, a high efficiency particulate air (HEPA) filter, or the like, but is not limited thereto.

The wireless vacuum cleaner 3000 according to an embodiment of the present disclosure may be a stick-type vacuum cleaner including the cleaner body 1000, the brush device 120, and the extension tube 130. However, the wireless vacuum cleaner 3000 according to an embodiment of the present disclosure is not limited to the stick-type vacuum cleaner, and the cleaner body 1000 may be an automatic mobile vacuum cleaner such as a robot cleaner.

Not all of the elements shown in FIG. 4A are essential. The wireless vacuum cleaner 3000 may be implemented with more elements than those shown in FIG. 4A, or may be implemented with fewer elements. For example, the wireless vacuum cleaner 3000 may be implemented with the cleaner body 1000 and the brush device 120, excluding the extension tube 130.

The cleaner body 1000 is a portion that may be held and moved by the user when cleaning, and the cleaner body 1000 may include the first suction motor 111 that forms vacuum inside the wireless vacuum cleaner 3000. The first suction motor 111 may be positioned within the dust bin 110, which accommodates foreign substances sucked from a surface being cleaned (e.g., floor, bedding, sofa, etc.). The cleaner body 1000 may further include the at least one main processor 1011, the battery 150, the memory 180 storing software related to control of the wireless vacuum cleaner 3000, or the like in addition to the first suction motor 111, but is not limited thereto. The cleaner body 1000 is described below in greater detail with reference to FIG. 4B. The cleaner body 1000 is not limited to a portion that may be held and moved by the user, and may be a main body of an automatically moving automatic mobile vacuum cleaner such as a robot cleaner. In this case, in the cleaner body 1000, a space detection sensor that detects a space and wheels for automatic movement may be attached to the cleaner body 1000.

The brush device 120 is a device that is in close contact with a surface being cleaned and may suck air and foreign substances from the surface being cleaned. The brush device 120 may also be represented as a vacuum cleaner head. The brush device 120 may be rotatably coupled to the extension tube 130. The brush device 120 may include a motor and a drum to which a rotating brush is attached, or the like, but is not limited thereto. According to an embodiment of the present disclosure, the brush device 120 may further include a processor for the brush device 120, for controlling communication with the cleaner body 1000. The types of brushes of the brush device 120 may vary.

The extension tube 130 may be formed of a pipe or flexible hose with a certain rigidity. The extension tube 130 may transfer, to the brush device 120, a suction force generated through a suction motor of the cleaner body 1000 and move air and foreign substances sucked through the brush device 120 to the cleaner body 1000. The extension tube 130 may be separably connected to the brush device 120. The extension tube 130 may be formed in a plurality of stages between the cleaner body 1000 and the brush device 120. Two or more extension tubes 130 may be provided.

According to an embodiment of the present disclosure, each of the cleaner body 1000, the brush device 120, and the extension tube 130 included in the wireless vacuum cleaner 3000 may include a power line (e.g., + power line and − power line) and a signal line.

The power line may be a line for transferring power supplied from the battery 150 to the cleaner body 1000 and the brush device 120 connected to the cleaner body 1000. The signal line, which differs from the power line, may be a line for transmitting and receiving signals between the cleaner body 1000 and the brush device 120. The signal line may be implemented to be connected to the power line within the brush device 120.

According to an embodiment of the present disclosure, each of the at least one main processor 1011 of the cleaner body 1000 and a processor of the brush device 120 may controls an operation of a switch element connected to a signal line, so that bidirectional communication may be performed between the cleaner body 1000 and the brush device 120. Hereinbelow, when the cleaner body 1000 and the brush device 120 communicate with each other through the signal line, the communication between the cleaner body 1000 and the brush device 120 may be defined as “signal line communication”. Meanwhile, the cleaner body 1000 and the brush device 120 may also communicate with each other by using I2C or UART.

According to an embodiment of the present disclosure, beyond detecting whether the brush device 120 is attached or detached, the cleaner body 1000 may identify a type of the brush device 120 and adaptively control an operation (e.g., drum RPM) of the brush device 120 according to a use environment state (e.g., hard floor, carpet, mat, corner, a lifted state from a surface being cleaned, etc.) of the brush device 120. For example, the main processor 1011 of the cleaner body 1000 may periodically communicate with the processor of the brush device 120 to transmit a signal for controlling an operation of the brush device 120 to the brush device 120. Hereinbelow, a configuration of the cleaner body 1000 is described in greater detail with reference to FIG. 4B.

FIG. 4B is a diagram for describing a vacuum cleaner body according to an embodiment of the present disclosure.

Referring to FIG. 4B, the cleaner body 1000 may include a suction force generation device (hereinafter referred to as “motor assembly 100”) that generates a suction force required to suck foreign substances on the surface being cleaned, the dust bin 110 (also referred to as “dust collector”) accommodating the foreign substances sucked from the surface being cleaned, the filter unit 140, the battery 150 capable of supplying power to the motor assembly 100, the charging terminal 151 connected to the charging terminal 211 of the station 2000 to charge the battery 150 from the station 2000, the pressure sensor 160, the user interface 170, the memory 180, a communication interface 190, a control unit 1100 responsible for overall control of the cleaner body, and the at least one main processor 1011. However, not all of the elements shown in FIG. 4B are essential. The cleaner body 1000 may be implemented with more elements than those shown in FIG. 4B, or may be implemented with fewer elements. In addition, although the at least one main processor 1011 included in the control unit 1100 and a first processor 1131 of a driving circuit 113 described below are separately described for convenience of description, the at least one main processor 1011 and the first processor 1131 may be implemented as a single processor or may be divided into a plurality of processors and mounted on the wireless vacuum cleaner 3000.

Each of the elements is discussed below.

The motor assembly 100 may include the first suction motor 111 that converts an electric force into a mechanical rotational force, a fan 112 connected to the first suction motor 111 to rotate, and a driving circuit (printed circuit board (PCB)) 113 connected to the first suction motor 111. The first suction motor 111 may form vacuum inside the wireless vacuum cleaner 3000. Here, vacuum refers to a state lower than atmospheric pressure. The first suction motor 111 may include a brushless motor (hereinafter referred to as “brushless direct current (BLDC) motor”), but is not limited thereto.

The driving circuit 1130 may include a first processor 1131 configured to control the first suction motor 111 and control communication with the brush device 120, a switch 1210 (e.g., field-effect transistor (FET), transistor, insulated gate bipolar transistor (IGBT), etc.) of an inverter 1200 for controlling power supply to the brush device 120 according to pulse-width modulation (PWM) switching, and a load detection sensor 1134 configured to detect a load of the brush device 120 (e.g., shunt resistor, shunt resistor and amplification circuit (operation amplifier (OP-AMP)), current detection sensor, magnetic field detection sensor (non-contact type), etc.), but is not limited thereto. Hereinbelow, for convenience of description, the FET is described as an example of the switch 1210, and the shunt resistor is described as an example of the load detection sensor 1134.

In addition, the driving circuit 113 may include a charge release switch 1217 for releasing charging between the station 2000 and the cleaner body 1000, and the switch 1210 of the inverter 1200 and the load detection sensor 1134 may be positioned in a battery pack including the battery 150 as a separate sub-printed circuit board (PCB) 1132 and, as is described below with reference to FIG. 8B, may be included in the battery control unit 155. The battery control unit 155 may include the battery processor 1551.

The first processor 1131 may obtain data related to a state of the first suction motor 111 (hereinafter referred to as “state data”) and transfer the state data of the first suction motor 111 to the main processor 1011. In addition, the first processor 1131 may control (e.g., turn on or turn off) an operation of the charge release switch 1217 and release the charge to the battery 150. The first processor 1131 may transfer, to the main processor 1011, data representing a current state of the brush device 120 or data representing a type of the brush device 120 included in a second signal. The battery processor 1551 described below may be the same as the first processor 1131, or the battery control unit 155 may include the first processor 1131.

The motor assembly 100 may be positioned in the dust bin 110. The dust bin 110 may be configured to filter out and collect dust or dirt in the air flowing in through the brush device 120. The dust bin 110 may be provided to be separable from the cleaner body 1000.

The dust bin 110 may collect foreign substances through a cyclone method that separates foreign substances by using a centrifugal force. The air obtained by removing foreign substances through the cyclone method may be discharged to the outside of the cleaner body 1000, and the foreign substances may be stored in the dust bin 110. A multi-cyclone may be arranged inside the dust bin 110. The dust bin 110 may be provided such that foreign substances are included on a lower side of the multi-cyclone. The dust bin 110 may include the dust bin door 114 provided to open the dust bin 110 when connected to the station 2000. The dust bin 110 may include first dust collection unit in which relatively large foreign substances are first collected and a second dust collection unit in which relatively small foreign substances are collected by a multi-cyclone. Both the first collection unit and the second collection unit may be provided to open to the outside when the dust bin door is opened.

The filter unit 140 may filter out ultrafine dust or the like that is not filtered out in the dust bin 110. The filter unit 140 may include an outlet through which air passing through a filter is discharged to the outside of the wireless vacuum cleaner 3000. The filter unit 140 may include a motor filter, a HEPA filter, or the like, but is not limited thereto.

The pressure sensor 160 may measure pressure inside the dust suction flow path (hereinafter referred to as a dust suction flow path pressure). In a case of the pressure sensor 160 provided at a suction end (e.g., a suction duct 40), a change in flow rate at the corresponding location may be measured by measuring static pressure. The pressure sensor 160 may be an absolute pressure sensor or a relative pressure sensor. When the pressure sensor 160 is an absolute pressure sensor, the main processor 1011 may sense a first pressure value before the first suction motor 111 is operated, by using the pressure sensor 160.

The dust suction flow path pressure measured by the pressure sensor 160 may be used to identify a current use environment state (e.g., a state of the surface being cleaned (floor, carpet, mat, corner, etc.), a lifted state from the surface being cleaned, or the like), or may be used to measure a suction force that varies depending on a degree of contamination of the dust suction flow path or a degree of dust collection).

The pressure sensor 160 may be positioned at the suction end (e.g., the suction duct 40). The suction duct 40 may be a structure that connects the dust bin 110 to the extension tube 130 or connects the dust bin 110 to the brush device 120 to allow fluid including foreign substances to move to the dust bin 110. The pressure sensor 160 may be positioned at the end of a straight section (or an inflection point between a straight section and a curved section) of the suction duct 40 in consideration of contamination by foreign matter/dust, but is not limited thereto. The pressure sensor 160 may be positioned in the middle of the straight section of the suction duct 40. Meanwhile, when the pressure sensor 160 is positioned in the suction duct 40, the pressure sensor 160 is positioned at the front end of the first suction motor 111 that generates suction force, and thus, the pressure sensor 160 may be implemented as a negative pressure sensor.

In the present disclosure, a case where the pressure sensor 160 is positioned in the suction duct 40 is described as an example, but is not limited thereto. The pressure sensor 160 may be positioned at a discharge end (e.g., within the motor assembly 100). When the pressure sensor 160 is positioned at the discharge end, the pressure sensor 160 is positioned at the rear end of the first suction motor 111 and may thus be implemented as a positive pressure sensor. In addition, a plurality of pressure sensors 160 may be provided in the wireless vacuum cleaner 3000.

The battery 150 may be mounted to be separable from the cleaner body 1000. The battery 150 may be charged by the station 2000 according to electrical connection between the charging terminal 211 provided in the station 2000 and the charging terminal 151 of the cleaner body 1000.

The cleaner body 1000 may include the communication interface 190 for performing communication with external devices. For example, the cleaner body 1000 may perform communication with the station 2000 (or the server 4000) through the communication interface 190. The communication interface 190 may include a short-range wireless communication interface, a long-distance communication interface, or the like. The short-range wireless communication interface may include a Bluetooth communication interface, a BLE communication interface, a near field communication (NFC) interface, a Wi-Fi local area network (WLAN) communication interface, a Zigbee communication interface, an infrared data association (IrDA) communication interface, a Wi-Fi Direct (WFD) communication interface, a ultra wideband (UWB) communication interface, an Ant+ communication interface, or the like, but is not limited thereto.

The user interface 170 may be provided on a part of the handle of the cleaner body 1000. The user interface 170 may include the input interface 171 and the output interface 173. The cleaner body 1000 may receive a user input related to an operation of the wireless vacuum cleaner 3000 through the user interface 170 or output information related to the operation of the wireless vacuum cleaner 3000. The input interface 171 may include a power button, a suction force intensity adjustment button, or the like. The output interface 173 may include an LED display, an LCD, a touch screen, or the like, but is not limited thereto.

The cleaner body 1000 may include the control unit 1100, and the control unit 1100 may include the at least one main processor 1011. The cleaner body 1000 may include one processor or may include a plurality of processors. For example, the cleaner body 1000 may include the at least one main processor 1011 connected to the user interface 170 and the first processor 1131 connected to the first suction motor 111. The at least one main processor 1011 may control an overall operation of the cleaner body 1000 or the wireless vacuum cleaner 3000. For example, the main processor 1011 may determine power consumption (suction force intensity) of the first suction motor 111, a drum RPM of the brush device 120, a trip level of the brush device 120, or the like.

The at least one main processor 1011 according to the present disclosure may include at least one of a central processing unit (CPU), a graphics processing unit (GPU), an accelerated processing unit (APU), a many integrated core (MIC), a digital signal processor (DSP), or a neural processing unit (NPU). The at least one main processor 1011 may be implemented in the form of an integrated system-on-chip (SoC) including one or more electronic components. The at least one main processor 1011 may also be represented as a micro-computer (a microprocessor computer, a microprocessor controller) (MICOM), a microprocessor unit (MPU), or a microcontroller unit (MCU).

The at least one main processor 1011 according to the present disclosure may be implemented as a single core processor or may be implemented as a multicore processor.

The memory 180 may store programs for processing and control of the at least one memory 180, or may store input/output data. For example, the memory 180 may store a pre-trained AI model (e.g., a support vector machine (SVM)) algorithm, etc.), state data of the first suction motor 111, a measurement value of the pressure sensor 160, state data of the battery 150, a compensation charging cycle of the battery 150, a most recent compensation charging time point data of the battery 150, state data of the brush device 120, error occurrence data (failure history data), power consumption of the first suction motor 111 corresponding to an operating condition, an RPM of a drum to which a rotating brush is attached, a trip level, or the like. The trip level is to prevent overload of the brush device 120 and may refer to a reference load value (e.g., a reference current value) for stopping the operation of the brush device 120.

The memory 180 may include an external memory 181 and an internal memory 183. For example, the memory 180 may include a storage medium of at least one type from among a flash memory type, a hard disk type, a multimedia card micro type, a card type (e.g., secure digital (SD) or extreme digital (XD) memory), random access memory (RAM), static RAM (SRAM), read-only memory (ROM), electrically erasable programmable ROM (EEPROM), programmable read-only memory (PROM), magnetic memory, magnetic disk, or optical disk. Programs stored in the memory 180 may be classified into a plurality of modules according to functions thereof.

FIG. 5 is a block diagram of a wireless vacuum cleaner according to an embodiment of the present disclosure.

Each configuration of the wireless vacuum cleaner 3000 is described in detail with reference to FIGS. 4A and 4B, and redundant descriptions thereof are omitted in FIG. 5.

Referring to FIG. 5, the cleaner body 1000 and the station 2000 may be electrically connected to each other through charging terminals 151 and 211 on both sides. First, when the cleaner body 1000 is discussed, the control unit 1100 is divided into (at least one) main processor 1011 and a sub-holder 1110, which may be configured with a single processor or a printed board assembly (PBA).

The station 2000 may include the main PBA 200 including a processor 203, the communication interface 201, and the pressure sensor 206. The pressure sensor 206 may be configured separately from the main PBA 200. TMR detecting dust bin 163 may be a docking detecting sensor and may detect a magnetic material attached to the dust collector to sense whether the cleaner body 1000 is docked to the station 2000.

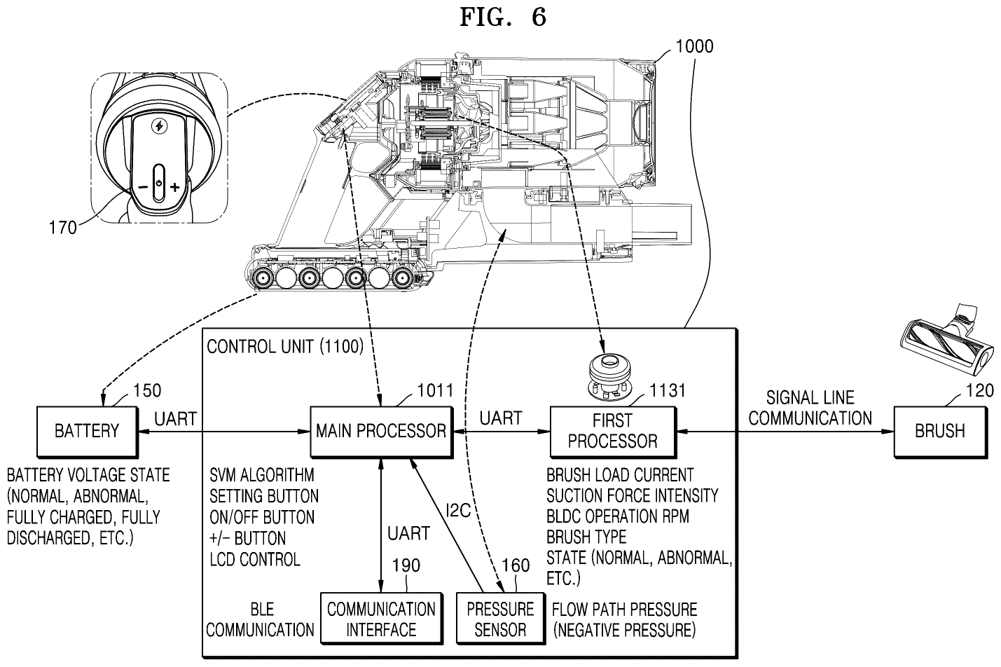

FIG. 6 is a diagram showing a communication connection structure between internal components of a vacuum cleaner body of a wireless vacuum cleaner according to an embodiment of the present disclosure.

A communication connection structure between components within a main body of the wireless vacuum cleaner 3000 according to an embodiment of the present disclosure is shown. The control unit 1100 may receive power supply through the battery 150 and control the first suction motor 111 to suck dust. In this case, the pressure sensor 160 may sense a pressure of a flow path through which dust sucked by the brush device 120 passes through while moving to the dust bin 110.

The control unit 1100 may include the at least one main processor 1011. The at least one main processor 1011 may perform UART communication with the communication interface 190, and the communication interface 190 may perform communication with an external device or the outside of the control unit 1100. The communication interface 190 may perform BLE communication with an external device or the outside of the control unit 1100. The at least one main processor 1011 may also receive a pressure sensing value of the dust suction flow path from the pressure sensor 160 through I2C communication. The at least one main processor 1011 may perform UART communication with the first processor 1131 of the driving circuit 113. The first processor 1131 may control the first suction motor 111 of the cleaner body 1000, obtain data related to a state of the first suction motor 111 (hereinafter referred to as “state data”), and transfer the state data of the first suction motor 111 to the main processor 1011 through UART communication. The first processor 1131 may perform communication with the brush device 120 through asynchronous communication.

A battery pack including the battery 150 may also include the battery control unit 155 including the battery processor 1551 configured to perform a control related to a battery cell and also check a charging state of the battery 150 and wake up the battery 150. The at least one main processor 1011 may transmit or receive data to or from the battery processor 1551 of the battery 150 through UART communication. In an embodiment of the present disclosure, the battery processor 1551 of the battery control unit 155 may be the first processor 1131, or the battery control unit 155 may include the first processor 1131 that is separate from the battery processor 1551.

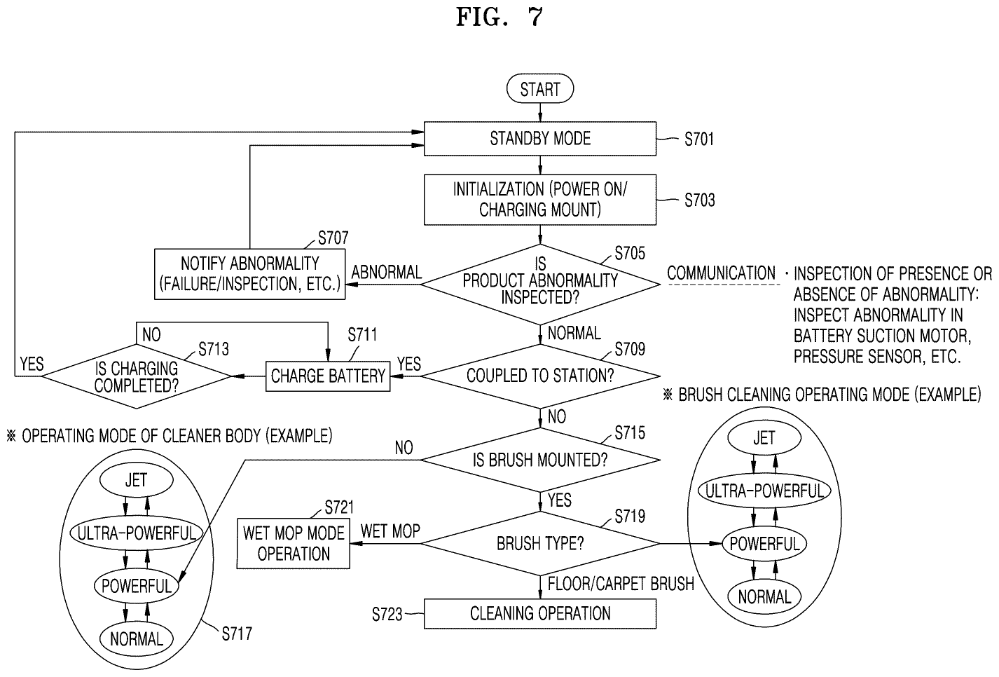

FIG. 7 is an operation flowchart of a wireless vacuum cleaner according to an embodiment of the present disclosure.

Referring to FIG. 7, in operation S701, the wireless vacuum cleaner 3000 may be in a standby state. In the standby state, as in operation S703, the wireless vacuum cleaner 3000 may be initialized by being powered on or according to a charging state. In operation S705, as part of initialization, the wireless vacuum cleaner 3000 performs self-diagnosis to check whether there are any problems with the product. For example, the wireless vacuum cleaner 3000 may determine whether there is abnormality with the wireless vacuum cleaner 3000 through communication with the server 4000 or the user terminal 5000, and may detect, for example, abnormalities in the battery 150, abnormalities in the first suction motor 111 and the second suction motor 207, abnormalities in the pressure sensor 160, or the like. When it is detected and determined that the wireless vacuum cleaner 3000 has abnormality, the at least one main processor 1011 of the wireless vacuum cleaner 3000 may display whether there is abnormality through the user interface 170, notify the user of items to be inspected, and return to an initial standby state, in operation S707. When the wireless vacuum cleaner 3000 is normal, it is detected whether the station 2000 and the cleaner body 1000 are coupled to each other through the station 2000, in operation S709. Here, “coupling” includes not only that the station 2000 and the cleaner body 1000 are electrically coupled but also that the station 2000 and the cleaner body 1000 are in mechanical close contact with each other. That the station 2000 and the cleaner body 1000 are “coupled” means that the cleaner body 1000 is mounted on the station 2000. However, the present disclosure is not limited thereto. The station 2000 may be mounted on or docked to the cleaner body 1000 thereunder, and the station 2000 and the cleaner body 1000 may be docked from each other's sides. The detection sensor may be in the station 2000 and/or the cleaner body 1000. When the station 2000 and the cleaner body 1000 are coupled to each other, the station 2000 may charge the battery 150 of the cleaner body 1000 through a charging circuit 2010, in operation S711, and the cleaner body 1000 may determine whether the battery 150 is fully charged and, when the charging is completed, the wireless vacuum cleaner 3000 returns to the initial standby state, in operation S713. When the charging of the battery 150 is not completed, the wireless vacuum cleaner 3000 may return to operation S709 and continue charging the battery 150.

In operation S715, when the station 2000 and the cleaner body 1000 are not coupled to each other, this is likely to be a case where the user wants to clean with the cleaner body 1000, and thus, the at least one main processor 1011 of the cleaner body 1000 may determine whether the brush device 120 is mounted on the cleaner body 1000, and when the brush is not mounted, the cleaner body 1000 may operate in a cleaner body (handy) operation mode, in operation S717. When the cleaner body 1000 is a robot cleaner on which a brush device is mounted by default, operation S715 may be omitted. The cleaner body (handy) operation mode is not necessarily limited, but may be divided into jet mode-ultra-powerful mode-powerful mode-normal mode in order of strongest suction force. However, this is only an example, and more diverse modes or simpler modes may be provided in order of strength of suction force. Normally, the cleaner body (handy) operation mode on which the brush device 120 is not mounted has stronger suction power than a brush operation mode on which the brush device 120 is mounted. This is because, when the brush device 120 is mounted and the suction force is high, the brush device 120 may stick to the floor. When it is determined that the brush device 120 is mounted on the cleaner body 1000, the at least one main processor 1011 of the cleaner body 1000 may determine whether the mounted brush device 120 is a brush or a wet mop, in operation S719. As a result of the determination, when the mounted brush device 120 is determined as a wet mop, the wireless vacuum cleaner 3000 operates as a wet mop mode, in operation S721. The wet mop mode is a mode in which an end of the cleaner body 1000 sprays water together during cleaning to facilitate mopping. When the brush device 120 mounted in the brush mode is a brush rather than a wet mop, a cleaning operation may be performed in operation S723. In this case, similar to the handy operation mode, the brush cleaning operation mode may be divided into jet mode-ultra-powerful mode-powerful mode-normal mode in order of strongest suction force. However, this is only an example, and more diverse modes or simpler modes may be provided in order of strength of suction force.

Table 1 is a table in which suction motor power consumption, usage time, and suction force according to the cleaner body (handy) operation mode and brush operation mode are organized, according to an embodiment of the present disclosure.

TABLE 1

| | | | Suction motor | | | | | |
|---|---|---|---|---|---|---|---|---|
| | | | Power | | | | Suction | |
| No | Operation mode | | consumption | | Usage time | | force | |
| 1 | Handy mode | Jet | 580 | W | 3 | minutes | 220 | W |
| 2 | | Ultra- | 320 | W | 10 | minutes | 125 | W |
| | | powerful | | | | | | |
| 3 | | Powerful | 113 | W | 30 | minutes | 140 | W |
| 4 | | Normal | 58 | W | 60 | minutes | 18 | W |
| 5 | Brush mode | Jet | 335 | W | 9 | minutes | 140 | W |
| 6 | | Ultra- | 213 | W | 15 | minutes | 90 | W |
| | | powerful | | | | | | |
| 7 | | Powerful | 115 | W | 25 | minutes | 40 | W |
| 8 | | Normal | 58 | W | 50 | minutes | 18 | W |

However, the power consumption, usage time, and suction force of the suction mode according to Table 1 may vary depending on product specifications such as battery specifications or suction motor specifications.

FIG. 8A is a simplified diagram showing that a wirelessly driven device is activated according to an operation event, according to an embodiment of the present disclosure.

Referring to FIG. 8A, a first device 810 and a second device 820 may be coupled to each other. The first device 810 and the second device 820 may be an electric device 800 configured to charge from the second device 820 to the first device 810 when coupled to each other, and in this case, the first device 810 may be a battery-powered device. In an embodiment of the present disclosure, the electric device 800 may be the wireless vacuum cleaner 3000, and the first device 810 may be the cleaner body 1000 and the second device 820 may be the station 2000. A main processor 815 of the first device 810 may be the main processor 1011 of the cleaner body 1000, a battery 813 may be the battery 150 of the cleaner body 1000, and a battery processor 817 may be the battery processor 1551 of the cleaner body 1000. A processor 825 of the second device 820 may be the processor 203 of the station 2000. A second switch unit 821 may be a second switch unit 21 of the station 2000, and a first switch unit 811 may be a first switch unit 11 of the cleaner body 1000. In an embodiment of the present disclosure, the first device 810 may be a main body of an automatic mobile cleaner (robot cleaner) body, and the second device 820 may be a station of the robot cleaner, and in this case, the electric device 800 may be an automatic mobile vacuum cleaner (robot cleaner).

In FIG. 8A, the first device 810 may be at the top and may be mounted on the second device 820 thereunder, but the present disclosure is not limited thereto. In an embodiment of the present disclosure, a structure in which the first device 810 is at the bottom and the second device 820 is at the top, a structure in which the first device 810 and the second device 820 are coupled to each other from a side, or a structure in which the two devices are coupled to each other in different directions are possible. According to an embodiment of the present disclosure, in any coupling structure, any method of activating the other device by operating a switch according to an operation event occurring on the side of one device may be applied. The “coupling” of the first device 810 and the second device 820 should be understood to include any form of coupling in which the first device 810 is electrically or mechanically connected to the second device 820. In other words, the “coupling” should be understood to include coupling in which the first device 810 is mounted on the second device 820 and any form in which the first device 810 is electrically or mechanically coupled to the side or bottom of the second device 820. However, because the fact that the first device 810 is “coupled” to the second device 820 denotes that the first device 810 may be electrically connected to the second device 820, the first device 810 and the second device 820 should be considered “coupled” even when the first device 810 and the second device 820 are electrically disconnected from each other. Accordingly, the “electrically disconnected” state as used herein does not mean a state in which electrical connection cannot be made, but rather a state in which electrical flow is temporarily interrupted, and should be understood to refer to a state in which the electrical connection between both devices may be resumed at any time by an electrical connection initiation operation on either side.

According to an embodiment of the present disclosure, the electric device 800 may include at least one of the first switch unit 811 or the second switch unit 821. In other words, the electric device 800 may include only the first switch unit 811, only the second switch unit 821, or both the first switch unit 811 and the second switch unit 821.

According to an embodiment of the present disclosure, the second device 820 may be a device that usually receives power via a wire, but is not limited thereto, and the second device 820 may also be a battery-powered device. Each of the cases is described separately below.

First, a case in which the electric device 800 includes only the first switch unit 811 according to an embodiment of the present disclosure is discussed. In this case, the second switch unit 821 may not be included. In this case, in a state in which the second device 820 and the first device 810 are connected to each other, power supplied from the battery 813 of the first device 810 to the main processor 815 of the first device 810 may be blocked by the first switch unit 811. In an embodiment of the present disclosure, the battery processor 817 may control on-off of the first switch unit 811. Because the second switch unit 821 is not present, when the first device 810 and the second device 820 are coupled to each other, the battery 813 may be continuously charged from the second device 820, and in this case, in order to save power due to a main operation of the first device 810 being controlled by the main processor 815, the battery processor 817 may turn off the first switch unit 811 and block connection between the battery 813 and the main processor 815. When the battery 813 is charged to a certain level before an operation event occurs on the side of the second device 820, the battery 817 may control to block charging from the second device 820 to the battery 813. In an embodiment of the present disclosure, the battery processor 817 may transmit to the processor 825 of the second device 820 that the battery 813 is charged to a certain level, and the processor 825 may turn off the second switch unit 821 to block charging.

In this state, the processor 825 of the second device 820 may receive an operation event. The operation event may be at least one of an event of pushing a user input button on the second device 820, an event of receiving a control signal from a computing device of the user or the user terminal 5000 through communication, an event of executing the control signal by a program stored in a memory of the second device 820, or an event in which the first device 810 is electrically coupled to the second device 820. When an operation event occurs, the processor 825 may transmit, to the battery processor 817, a control signal corresponding to the detected operation event. In an embodiment of the present disclosure, the battery processor 817 may be activated by using the turning on of the second switch unit 821 as a wake-up signal, and the battery processor 817 may control the first switch unit 811 to be turned on based on the received control signal corresponding to the operation event. In an embodiment of the present disclosure, when the second switch unit 821 is turned on, the battery processor 817 may be activated by using a charging signal generated at a charging terminal of the battery 813 as a wake-up signal. When the first switch unit 811 is turned on, an electrical connection is made between the battery 813 and the main processor 815, and the main processor 815 may be activated.

A case in which the electric device 800 includes only the second switch unit 821 according to an embodiment of the present disclosure is discussed. Because the first device 810 does not include the first switch unit 811, the main processor 815 may be connected to the battery 813. However, when the battery 813 is fully charged or a certain condition is reached, the processor 825 may turn off the second switch unit 821 so that the second device 820 can no longer charge the battery 813 of the first device 810. Because the second switch unit 821 is turned off, in the electric device 800, power consumption for charging the battery 813 may be reduced and frequent charging of the battery 813 may be avoided. In this state, the processor 825 of the second device 820 may detect an operation event. A detailed description of the operation event is provided above, and thus is omitted herein. The processor 825 may turn on the second switch unit 821 based on the detected operation event. When the second switch unit 821 is turned on, the battery 813 may be charged. In an embodiment of the present disclosure, the battery processor 817 may be activated by using the turning on of the second switch unit 821 as a wake-up signal. According to an embodiment of the present disclosure, in addition to operations required when the second switch unit 821 is in an off state, various elements deactivated to reduce power consumption may be activated by the activated battery processor 817 or the main processor 815.

A case in which the electric device 800 includes both the first switch unit 811 and the second switch unit 821 according to an embodiment of the present disclosure is discussed. In an embodiment of the present disclosure, in a state in which the second device 820 and the first device 810 are connected to each other, power supplied from the battery 813 of the first device 810 to the main processor 815 of the first device 810 may be blocked. This operation may be performed by the battery processor 817. In an embodiment of the present disclosure, electrical connection between the two devices may be blocked to prevent frequent charging from the second device 820 to the first device 810, in which case the electrical blockage may be made in the first device 810 or may be made by the processor 825 of the second device 820. An operation event may occur while the electrical connection between the two devices is blocked. A detailed description of the operation event is provided above, and thus is omitted herein. When the second switch unit 821 is turned on by the processor 825 that has detected to the operation event, the battery 813 and the battery processor 817 may be activated. Accordingly, in a state in which the first device 810 and the second device 820 are electrically blocked from each other, and the main processor 815 and the battery 813 of the first device 810 are electrically blocked from each other, a signal generated by the operation event and/or when the second switch unit 821 operates may be used as a signal for waking up the first device 810—especially the battery 813 and the battery processor 817. In an embodiment of the present disclosure, when the battery 813 and the battery processor 817 of the first device 810 are activated, the battery processor 817 may activate the main processor 815 of the first device 810.

FIG. 8B is a block diagram of a wireless vacuum cleaner according to an embodiment of the present disclosure.

Referring to FIG. 8B, the difference from FIG. 5 is that the cleaner body 1000 has the first switch unit 11 and the station 2000 has the second switch unit 21. In an embodiment of the present disclosure, the wireless vacuum cleaner 3000 may not include either the first switch unit 11 or the second switch unit 21 or may include both.

The station 2000 may include a switched mode power supply (SMPS) as the power supply device 208 for supplying direct current power from an input power supply 10, which is an indirect current power supply, the communication interface 201, the user interface 204, and a main PBA (station main PBA) 200 including the processor 203. The station 2000 may include the charging terminal 211 for charging the battery 150 of the cleaner body 1000. The cleaner body 1000 may include the control unit 1100 including the main processor 1011 responsible for overall control of the cleaner body 1000, the battery 150, and the charging terminal 151 for electrical connection with the charging terminal 211 of the station 2000 to charge the battery 150. The battery 150 may include a battery cell array 153 in which actual electrical charging occurs, the battery control unit 155 including the battery processor 1551 configured to monitor and control a state of the battery 150, and the first switch unit 11 configured to be operated by the battery processor 1551 as the second switch unit 21 is turned on. In an embodiment of the present disclosure, the battery control unit 155 may be positioned inside a battery pack including the battery 150, and the battery processor 1551 included in the battery control unit 155 may control turning on or off of the first switch unit 11 so that driving power is supplied from the battery 150 to activate the main processor 1011 of the cleaner body 1000. The battery processor 1551 may be a micro central unit (MCU). In an embodiment of the present disclosure, the battery processor 1551 may be the first processor 1131.

The control unit 1100 of the cleaner body 1000 may be formed of a printed board assembly (PBA). The control unit 1100 may include the at least one main processor 1011 responsible for a control operation of the cleaner body 1000, the communication interface 190 for performing communication with the station 2000 or an external device—the server 4000 or user terminal 5000, and the user interface 170. The user interface 170 may include the input interface 171 for receiving a user input and the output interface 173 for displaying information to the user.

The processor 203 of the station 2000 may also be referred to as “station processor”, and may control components inside the station 2000 by receiving a direct current from the SMPS, which is the power supply device 208, and control a charging operation for supplying power to the battery 150 of the cleaner body 1000. The processor 203 of the station 2000 may control the communication interface 201, the user interface 204, or the like. The user interface 204 may include a user input button, and an operation event may occur by pushing the user input button. When the second switch unit 21 is turned on under the control by the processor 203 based on the operation event, the battery processor 1551 may be activated. The activated battery processor 1551 may control the first switch unit 11 of the cleaner body 1000 to be turned on, and when the first switch unit 11 is turned on, the battery 150 and the main processor 1011 may be connected so that the main processor 1011 is activated.

The activated main processor 1011 may be responsible for overall control of the cleaner body 1000. In an embodiment of the present disclosure, the main processor 1011 may control the communication interface 190, the user interface 170, or the like of the cleaner body 1000. The communication interface 190 may support BLE communication, but is not limited thereto, and may support communication such as Wi-Fi or Bluetooth (BT). The user interface 170 may include the input interface 171 through which the user may issue an operation command, and the output interface 173 that may show a current state of the wireless vacuum cleaner 3000 to the user.

In an embodiment of the present disclosure, when the cleaner body 1000 is coupled to the station 2000 and charging of the battery 150 is completed, the battery processor 1551 may block the power supply from the battery 150 to the main processor 1011 (blocking connection B in FIG. 8B), thereby minimizing power consumed by the cleaner body 1000. Blocking power from the battery 150 of the cleaner body 1000 to the main processor 1011 (blocking the connection B) may reduce power consumption when the cleaner body 1000 is left for a long period of time without cleaning or when the cleaner body 1000 is left at the station 2000 for a long time, and natural discharge of the battery 150 may be improved.

In an embodiment of the present disclosure, when power from the battery 150 to the main processor 1011 is completely blocked (blocking the connection B) in a state in which the station 2000 and the cleaner body 1000 are coupled to each other, the processor 203 of the station 2000 may turn off the second switch unit 21 to turn off connection A so that no power consumption occurs in the battery 150, so that the battery 150 is in a shut-down state where the battery 150 is no longer charged. In an embodiment of the present disclosure, the second switch unit 21 may be turned off by the battery processor 1551. In an embodiment of the present disclosure, in order to block the connection A so that the battery 150 is in the shut-down state, the battery processor 1551 may control the first switch unit 11 to be turned off.

In an embodiment of the present disclosure, in a state in which the connection A and the connection B are blocked, when the user presses a dust discharge button—user input button—of the user interface 204 of the station 2000, the corresponding operation may be an action event and the processor 203 may turn on the second switch unit 21. In this case, pressing the dust discharge button to generate an operation event is only an example, and the operation event may occur in various ways. For example, an operation event may be generated periodically at long time intervals (e.g., 7 to 9 hours) by a program stored in the memory 202 inside the station 2000. In another example, the user may remotely generate an operation event for dust discharge from the user terminal 5000—for example, the user's smartphone, smart watch, or mobile phone. In another example, the server 4000 may generate an operation event as part of failure diagnosis to determine whether the station 2000 is operating normally.

In an embodiment of the present disclosure, let's assume that the operation event is an event that occurs to discharge dust from the cleaner body 1000 to the station 2000. To this end, the user presses the dust discharge button-user input button. The processor 203 may recognize this operation as an operation event and turn on the second switch unit 21. The battery 150 may be woken up (or activated) through the charging terminal 151 on the side of the cleaner body 1000 electrically connected to the second switch unit 21, and the activated battery processor 1551 may control the first switch unit 11 to be turned on so that power is supplied to the control unit 1100 including the main processor 1011. In other words, even when the battery 150 is shut down, the main processor 1011 of the cleaner body 1000 may detect and recognize an operation of the station 2000 by turning on the second switch unit 21 is according to an operation event of the station 2000. In this case, when the battery 150 is charged by turning on the second switch unit 21, a charging signal is detected through a charging terminal 157, and thus, the battery processor 1551 may be activated by using the detected charging signal as a wake-up signal.

Accordingly, the battery processor 1551 may control the first switch unit 11 to activate connection B so as to sequentially wake up the main processor 1011 including the control unit 1100. By this method, power consumption of the battery 150 of the cleaner body 1000 may be minimized. In particular, power consumption and natural discharge loss of the battery 150 may be minimized under conditions where the wireless vacuum cleaner 3000 is left unattended for a long period of time.

In an embodiment of the present disclosure, the cleaner body 1000 may not include the first switch unit 11. In this case, the connection B between the battery 150 and the main processor 1011 may not be released and may be always connected. Under conditions such as when the battery 150 is fully charged, the battery processor 1551 or the processor 203 of the station 2000 may turn off the second switch unit 21 and block connection A. When the second switch unit 21 is turned off, electrical connection between the station 2000 and the cleaner body 1000 may be temporarily released and charging of the battery 150 is stopped. Accordingly, frequent charging of the battery 150 may be blocked. In this state, when an operation event occurs, the processor 203 of the station 2000 may detect an operation event, and the processor 203 may turn on the second switch unit 21 based on the detected operation event. When the second switch unit 21 is turned on, electrical connection between the station 2000 and the battery 150 may be activated and the battery 150 may be charged. In an embodiment of the present disclosure, before the second switch unit 21 is turned on, the cleaner body 1000 may be in a state in which only minimum components including the main processor 1011 are activated, but after the second switch unit 21 is turned on, all components required for an operation of the cleaner body 1000 may be activated.

In an embodiment of the present disclosure, the cleaner body 1000 may include the first switch unit 11 and the station 2000 may not include the second switch unit 21. Because the second switch unit 21 is not present, electrical connection between the station 2000 and the cleaner body 1000 is maintained without being blocked. In order to minimize power consumption due to an operation of the main processor 1011, the battery processor 1551 may turn off the first switch unit 11 to reduce power consumption. Even in this state, the battery 150 may remain charged from the station 2000. When an operation event occurs in the station 2000, the processor 203 of the station 2000 may detect the operation event and transmit a control signal corresponding to the detected operation event to the battery processor 1551. The battery processor 1551 may turn on the first switch unit 11 based on the received control signal corresponding to the operation event, unblock electrical connection between the battery 150 and the main processor 1011, and activate the main processor 1011.

FIG. 9A is a detailed circuit diagram of a first switch unit and a second switch unit according to an embodiment of the present disclosure.

Referring to FIG. 9A, the first switch unit 11 may be a circuit belonging to the cleaner body 1000, and the second switch unit 21 may be a circuit belonging to the station 2000. The first switch unit 11 may include a first switch 12, which is an N-channel field-effect transistor (FET), and the second switch unit 21 may include a second switch 22, which is an N-channel FET. It is only an example that the first switch 12 and the second switch 22 are N-channel FETs, and the first switch 12 and the second switch 22 may be replaced by other switches (IGBT, TR, FET, etc.) that are capable of performing the same switching operation.

The power supply device 208 of the station 2000 may receive indirect current power from an input power 10. The power supply device 208 may include an SMPS and may output an indirect current voltage, supply power to the main PBA 200 on the side of the station 2000, and charge the battery 150 of the cleaner body 1000.

In the first switch unit 11 and the second switch unit 21, various switch elements such as FET, TR, or IGBT may be applied. In addition, as shown in FIG. 9A, the switch element may apply an N-channel FET to a “−” line.

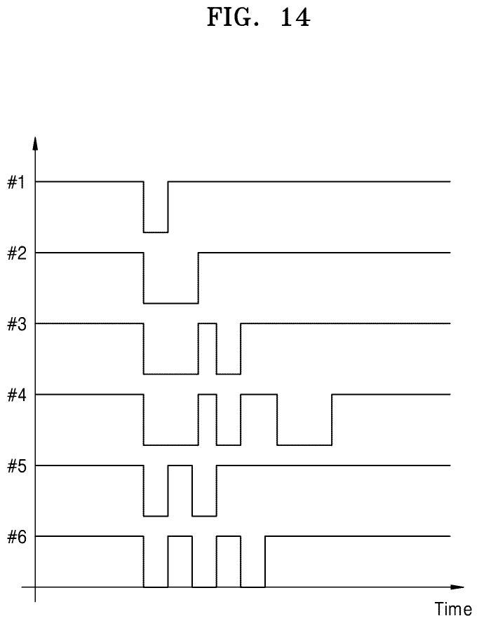

Referring to FIG. 9A, when an operation event occurs, the processor 203 may receive the operation event and operate the second switch 22 of the second switch unit 21. In an embodiment of the present disclosure, the processor 203 may vary a turn-on (PWM switching) pattern of the second switch 22 depending on a type of operation event. An example of varying the turn-on pattern depending on the type of operation event is described in greater detail with reference to FIG. 14.

FIG. 14 is a waveform diagram showing various turn-on patterns of the second switch unit according to an embodiment of the present disclosure.

The waveform diagram of FIG. 14 may be a gate signal for turning on the second switch 22 in the second switch unit 21, or vice versa when an element of the second switch 22 is an N-channel FET or a negative-positive-negative (NPN) transistor.

Because #1 to #6 all show different switching patterns, in an embodiment of the present disclosure, the battery processor 1551 may determine an operation of the wireless vacuum cleaner 3000 according to the different switching patterns occurring in the second switch unit 21. As shown in FIG. 14, in a pattern in which the second switch unit 21 is turned on, the type of operation event may vary depending on a length of on and off periods of the second switch unit 21 and the number of on and off repetitions of the second switch unit 21.

In an embodiment of the present disclosure, each of operation event #1 to #6 may be stored as a mapping table in the memory 202 of the station 2000. The cleaner body 1000 may also store the same mapping table in the memory 180 and determine the kind of operation event based on the received switching pattern.

Table 2 is an operation mapping table of the wireless vacuum cleaner 3000 corresponding to the switching patterns (operation events) of #1 to #6 according to an embodiment of the present disclosure.

TABLE 2

| Switching pattern | Operation of wireless vacuum |
|---|---|
| (operation event) | cleaner 3000 |
| #1 | Dust emptying operation |
| #2 | Station 2000 dust bag replacement required |
| #3 | Filter replacement required |
| #4 | Filter misassembled |
| #5 | SW update |
| #6 | Robot cleaner coupling error |

Table 2 is only an example, and the manufacturer may vary the switching pattern: wireless vacuum cleaner 3000 operation mapping by setting, thereby further increasing the number of wireless vacuum cleaner 3000 operation mappings. For example, when a SW update event occurs on the station 2000 side, in order to reflect this in the cleaner body 1000, a PWM switching pattern may be input to the second switch unit 21 in the pattern #5. The battery processor 1551 of the cleaner body 1000 may recognize the pattern #5 and identify that a SW update from among operation events has occurred according to the recognized pattern #5, and the battery control unit 155 may operate the first switch unit 11 according to a switching pattern corresponding to #5 so that the main processor 1011 of the cleaner body 1000 may recognize the SW update. According to an embodiment of the present disclosure, the control unit 1100 may control the output interface 173 to display, according to the recognized different patterns, corresponding operation event-related information on the output interface 173.

Returning to FIG. 9A, when the second switch 22 of the second switch unit 21 is operated by the processor 203 of the station 2000, the battery 150 and the battery processor 1551 may be activated through electrical connection between the charging terminal 211 on the station 2000 and the charging terminal 151 on the cleaner body 1000 side. In an embodiment of the present disclosure, the battery processor 1551 may be activated by detecting a voltage generated at the battery terminal of the battery 150 through the charging terminal 151 as a wake-up signal.

The activated battery processor 1551 may operate the first switch unit 11 (first switch 12) and electrically connect the battery 150 and the main processor 1011 of the cleaner body 1000 to each other, so that the control unit 1100 may be controlled to be activated. By this method, even when there is no power consumption in the cleaner body 1000 and the main processor 1011 and the battery control unit 155 are in an inactive state, the control unit 1100 may be activated through an operation event occurring on the station 2000 side.

FIG. 9B is a detailed circuit diagram of a first switch unit and a second switch unit according to an embodiment of the present disclosure.

Referring to FIG. 9B, while the switch on the “−” line of FIG. 9A is an N-channel FET in the second switch unit 21, a P-channel FET is used for a fourth switch 24 over the second switch unit 21. Likewise, a P-channel FET is used for a third switch 15 over the first switch unit 11. Other than these differences, operations of the first switch unit 11 and the second switch unit 21 according to FIG. 9B are the same as those in FIG. 9A.

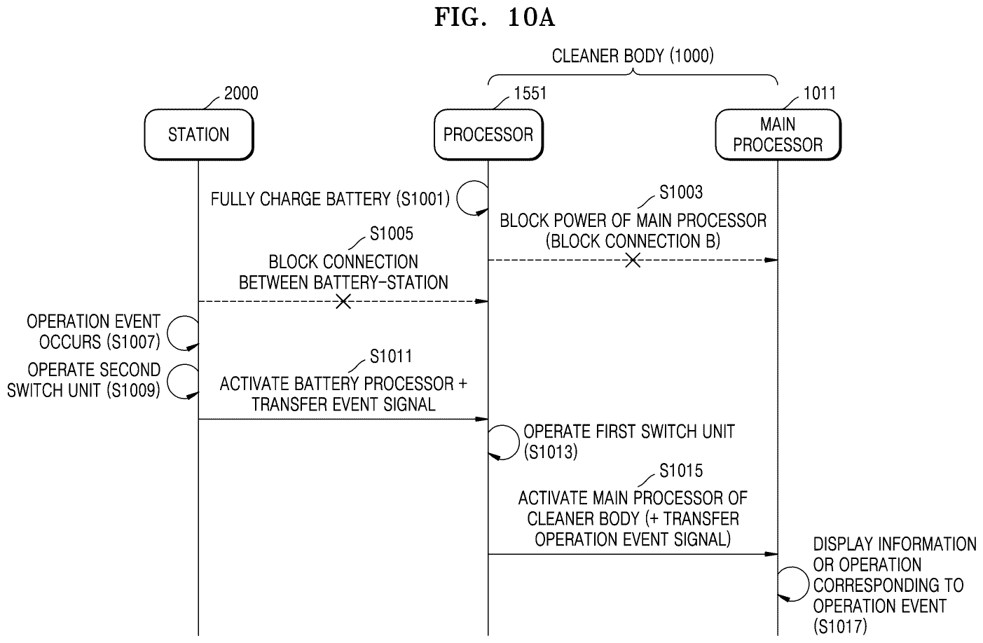

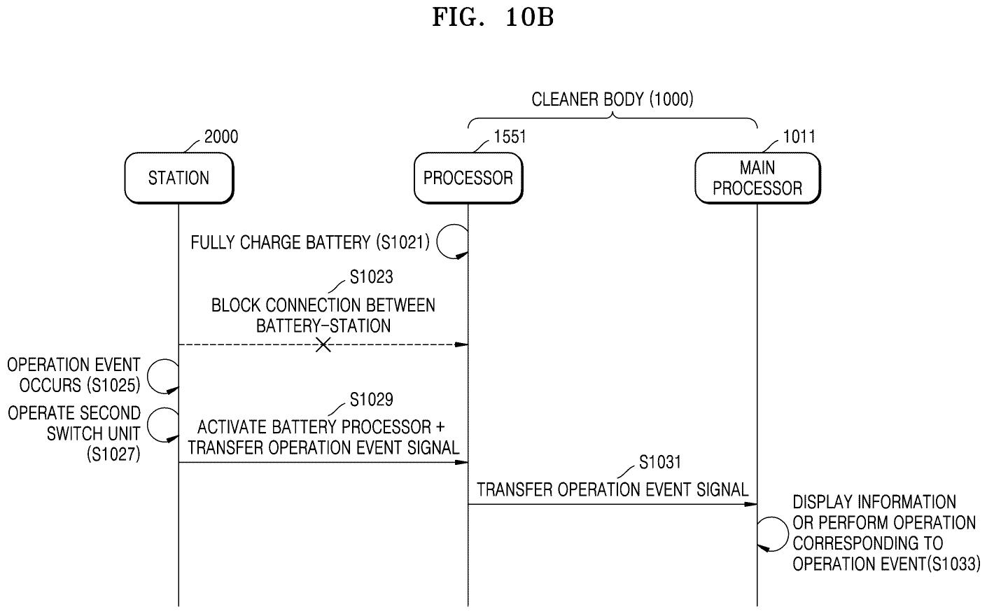

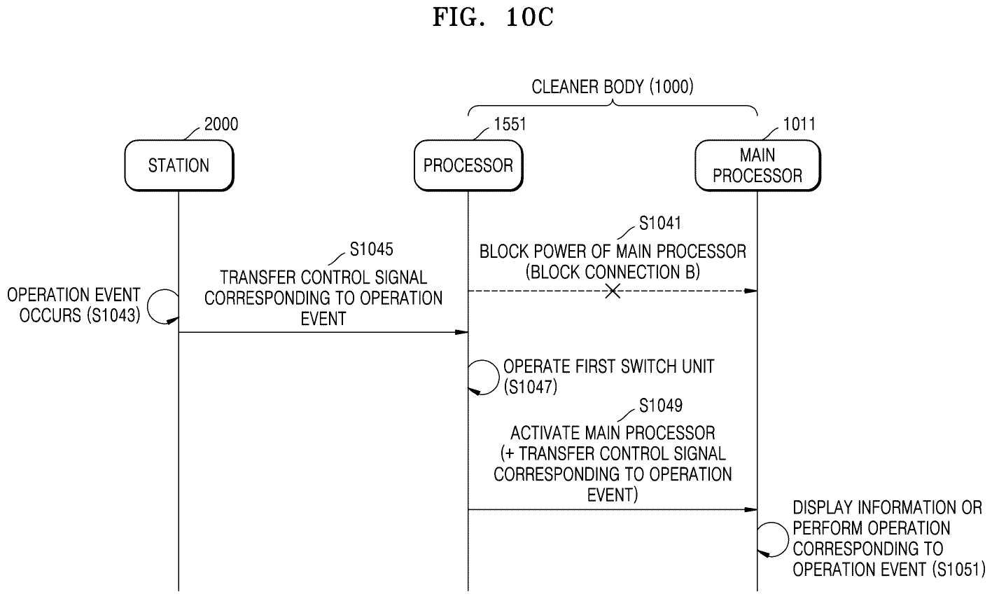

FIG. 10A is a sequence diagram showing that a vacuum cleaner body is activated, according to an embodiment of the present disclosure.

Referring to FIG. 10A, a sequence diagram is shown with the station 2000, the battery processor 1551, and the main processor 1011 of the cleaner body 1000 as the main elements of operation.

First, in operation S1001, the battery 150 may be fully charged through the charging terminal 211 of the station 2000. When the battery 150 is fully charged, the battery processor 1551 may block connection (connection B) between the main processor 1011 and the battery 150, in operation S1003, to prevent further power consumption in the main processor 1011.

In operation S1005, the processor 203 of the station 2000 the processor 203 of the station 2000 may block connection (connection A) between the battery 150 and the station 2000 to prevent further power consumption in the battery pack (battery 150, battery control unit 155, or the like). When operation S1005 is completed, the cleaner body 1000 may reach a state in which power is no longer is consumed.

In operation S1007, an operation event may occur in the station 2000. The operation event may be at least one of an event in which the user pushes a dust discharge button (user input button) to discharge dust from the station 2000, an event in which the station 2000 receives a control signal from the outside through communication, an event of executing a control signal by an internal program stored in the memory 202 of the station 2000, or an event in which the cleaner body 1000 is coupled to the station 2000. In the event in which the cleaner body 1000 is coupled to the station 2000, the cleaner body 1000 is a main body of an automatic mobile cleaner (robot cleaner), and the event in which the cleaner body 1000 is electrically coupled to the station 2000 may be an event in which the main body of the automatic mobile vacuum cleaner is docked to the station 2000 and electrically coupled to the station 2000.

In operation S1009, when an operation event occurs, the processor 203 of the station 2000 may turn on the second switch unit 21. In an embodiment of the present disclosure, the processor 203 may vary a PWM switching pattern for operating the second switch unit 21, depending on the type of operation event.

In operation S1011, the battery 150 and the battery processor 1551 may be activated by an operation of the second switch unit 21. In an embodiment of the present disclosure, the battery processor 1551 may recognize the PWM switching pattern through which the processor 203 of the station 2000 operates the second switch unit 21, and determine which operation event has occurred.

The battery processor 1551 may operate the first switch unit 11, in operation S1013, and activate the main processor 1011 on the cleaner body 1000 side, in operation S1015. In an embodiment of the present disclosure, the activated main processor 1011 may recognize a PWM switching pattern of the second switch unit 21, and determine a type of an operation event occurring in the station 2000 based on a mapping table of an operation event stored in the memory 180−(PWM) switching pattern.

In operation S1017, the main processor 1011 of the cleaner body 1000 may control the cleaner body 1000 to perform a required operation according to the determined operation event. For example, when the operation event must display specific information, the corresponding information may be displayed through the output interface 173, or when the operation event is emptying the dust bin 110, an operation of emptying the dust bin 110 may be performed.

FIG. 10B is a sequence diagram showing that the vacuum cleaner body is activated in the absence of a first switch unit, according to an embodiment of the present disclosure.

Referring to FIG. 10B, a sequence diagram is shown with the station 2000, the battery processor 1551, and the main processor 1011 of the cleaner body 1000 as the main elements of operation. FIG. 10B is a sequence diagram of a case where the battery 150 of the cleaner body 1000 does not include the first switch unit 11.

First, in operation S1021, the battery 150 may be fully charged through the charging terminal 211 of the station 2000. When the battery 150 is fully charged, the processor 203 of the station 2000 may turn off the second switch unit 21 and block connection (connection A) between the station 2000 and the battery 150, in operation S1023. In order to turn off the second switch unit 21, the processor 203 of the station 2000 may receive, from the battery processor 1551, information indicating that the battery 150 is fully charged, and turn off the second switch unit 21 based on the received information.

In operation S1025, an operation event may occur in the station 2000. The operation event is described in detail with reference to FIG. 10A and thus is omitted herein.

In operation S1027, when an operation event occurs, the processor 203 of the station 2000 may turn on the second switch unit 21. In an embodiment of the present disclosure, the processor 203 may vary a PWM switching pattern for operating the second switch unit 21, depending on the type of operation event.

In operation S1029, the battery 150 and the battery processor 1551 may be activated by an operation of the second switch unit 21. In an embodiment of the present disclosure, the battery processor 1551 may recognize the PWM switching pattern through which the processor 203 of the station 2000 operates the second switch unit 21, and determine which operation event has occurred.

In operation S1030, the battery processor 1551 may transfer, to the main processor 1011, a signal corresponding to the determined operation event or the operation event itself. In an embodiment of the present disclosure, the activated main processor 1011 may directly recognize a PWM switching pattern of the second switch unit 21, and determine a type of an operation event occurring in the station 2000 based on a mapping table of an operation event stored in the memory 180−(PWM) switching pattern.

In operation S1033, the main processor 1011 of the cleaner body 1000 may control the cleaner body 1000 to perform a required operation according to the determined operation event. For example, when the operation event must display specific information, the corresponding information may be displayed through the output interface 173, or when the operation event is emptying the dust bin 110, an operation of emptying the dust bin 110 may be performed.

FIG. 10C is a sequence diagram showing that the vacuum cleaner body is activated in the absence of a second switch unit, according to an embodiment of the present disclosure.

Referring to FIG. 10C, a sequence diagram is shown with the station 2000, the battery processor 1551, and the main processor 1011 of the cleaner body 1000 as the main elements of operation. FIG. 10C is a sequence diagram of a case where the station 2000 does not include the second switch unit 21.

In operation S1041, the battery processor 1551 may turn off the first switch unit 11 and block connection between the main processor 1011 and the battery 150 (connection B). Because the control unit 1100 including the main processor 1011 is deactivated, power consumption of the wireless vacuum cleaner 3000 may be reduced.

In operation S1043, an operation event may occur in the station 2000. The operation event is described in detail with reference to FIG. 10A and thus is omitted herein.

In operation S1045, when the operation event occurs, the processor 203 of the station 2000 may transmit a control signal corresponding to the operation event to the battery processor 1551, and in operation S1047, the battery processor 1551 may turn on the first switch unit 11. In operation S1049, when the first switch unit 11 is turned on, the main processor 1011 may be activated. In an embodiment of the present disclosure, the battery processor 1551 may transmit, to the main processor 1011, the received control signal corresponding to the operation event. In an embodiment of the present disclosure, a PWM switching pattern for operating the first switch unit 11 may vary depending on the control signal corresponding to the operation event received by the battery processor 1551, and the main processor 1011 may recognize the operation event according to the varied PWM switching pattern.

In operation S1051, the main processor 1011 of the cleaner body 1000 may control the cleaner body 1000 to perform a required operation according to the determined operation event. For example, when the operation event must display specific information, the corresponding information may be displayed through the output interface 173, or when the operation event is emptying the dust bin 110, an operation of emptying the dust bin 110 may be performed.

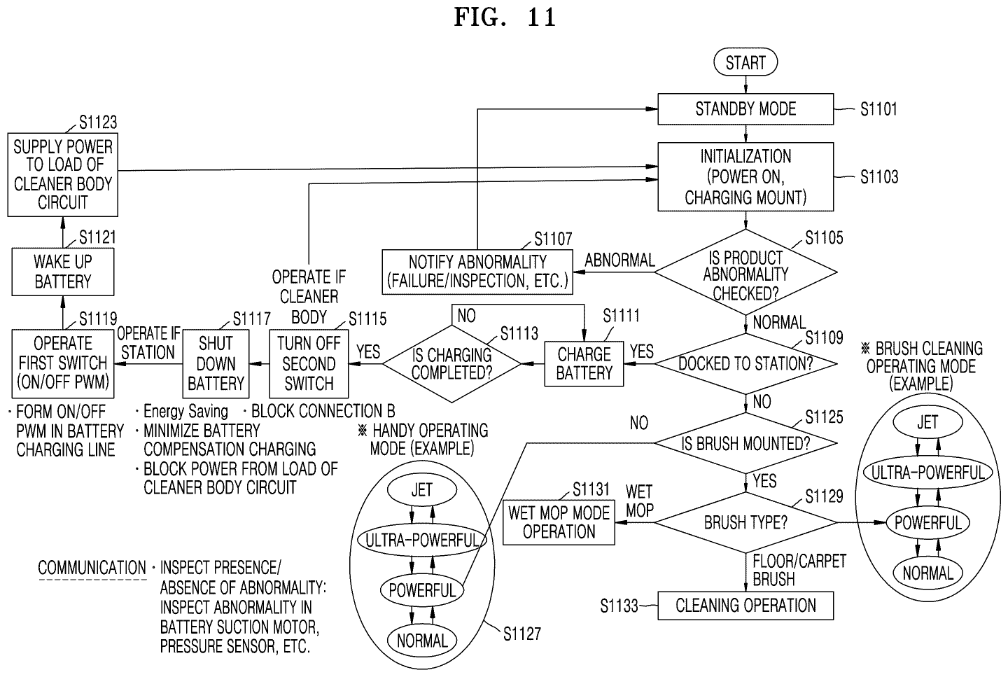

FIG. 11 is a flowchart showing that a vacuum cleaner body is activated, according to an embodiment of the present disclosure.

Referring to FIG. 11, in operation S1101, the wireless vacuum cleaner 3000 may be in a standby state. In the standby state, as in operation S1103, the wireless vacuum cleaner 3000 may be initialized by being powered on or according to a charging state. In operation S1105, as part of initialization, the wireless vacuum cleaner 3000 performs self-diagnosis to check whether there are any problems with the product. For example, the wireless vacuum cleaner 3000 may determine whether there is abnormality with the wireless vacuum cleaner 3000 through communication with the server 4000 or the user terminal 5000, and may detect, for example, abnormalities in the battery 150, abnormalities in the first suction motor 111 and the second suction motor 207, abnormalities in the pressure sensor 160, or the like. When it is detected and determined that the wireless vacuum cleaner 3000 has abnormality, the at least one main processor 1011 of the wireless vacuum cleaner 3000 may display whether there is abnormality through the user interface 170, notify the user of items to be inspected, and return to an initial standby state, in operation S1107. When the wireless vacuum cleaner 3000 is normal, it is detected whether the station 2000 and the cleaner body 1000 are docked to each other through the station 2000, in operation S1109. Here, “docking” may include not only that the station 2000 and the cleaner body 1000 are electrically coupled but also that the station 2000 and the cleaner body 1000 are in mechanical close contact with each other. That the station 2000 and the cleaner body 1000 are “docked” means that the cleaner body 1000 is mounted on the station 2000. However, the present disclosure is not limited thereto. The station 2000 may be mounted on or coupled to the cleaner body 1000 thereunder, and the station 2000 and the cleaner body 1000 may be docked from each other's sides. The detection sensor may be in the station 2000 and/or the cleaner body 1000. When the station 2000 and the cleaner body 1000 are docked, the station 2000 may charge the battery 150 of the cleaner body 1000 through the charging circuit 2010, in operation S1111, and when charging of the battery 150 is not completed in operation S1113, the wireless vacuum cleaner 3000 may return to operation S1111 and continuously charge the battery 150. In operation S1113, the cleaner body 1000 may determine whether charging of the battery 150 is completed, and when charging is completed, the battery processor 1551 may turn off the first switch unit 11 and block electrical connection between the battery 150 and the main processor 1011 of the cleaner body 1000 (blocking connection B), and the wireless vacuum cleaner 3000 may return to its initial standby state, in operation S1115. In an embodiment of the present disclosure, when the first switch unit 11 is not present, blocking connection B described above does not occur and, as described below, the second switch unit 21 may activate connection between the station 2000 and the battery 150 so that the battery processor 1551 may be immediately activated.

When the first switch unit 11 is present and the electrical connection between the battery 150 and the main processor 1011 of the cleaner body 1000 is blocked by the battery processor 1551, the battery processor 1551 may shut down the battery 150 so that power is no longer consumed in the cleaner body 1000, in particular, a battery pack, thereby minimizing compensation charging from the station 2000 to the battery 150, in operation S1117. In addition, a load of the cleaner body 1000 may be disconnected so that power consumption may be minimized.

In this state, when an operation event occurs on the station 2000 side, the processor 203 of the station 2000 may operate the second switch unit 21 according to an on-off PWM switching based on the operation event, in operation S1119. In addition, by the on-off PWM switching operation of the second switch unit 21, the battery 150 and the battery processor 1551 may be activated in operation S1121.

In an embodiment of the present disclosure, in the case where the second switch unit 21 is not present, when an operation occurs on the station 2000 side, the processor 203 of the station 2000 may transmit, to the battery processor 1551, the operation event or a control signal corresponding to the operation event, and the battery processor 1551 may turn on the first switch unit 11 according to the transmitted operation event or control signal corresponding to the operation event, to activate the main processor 1011.

In operation S1123, the activated battery processor 1551 may connect the load of the cleaner body 1000—including the main processor 101—and the battery 150 to each other and control power to be supplied.

Returning to operation S1109, when the station 2000 and the cleaner body 1000 are not docked to each other, this is likely to be a case where the user wants to clean with the cleaner body 1000, and thus, in operation S1125, the at least one main processor 1011 of the cleaner body 1000 may determine whether the brush device 120 is mounted on the cleaner body 1000, and when the brush is not mounted, the cleaner body 1000 may operate in the cleaner body (handy) operation mode, in operation S1127. When the cleaner body 1000 is a robot cleaner on which a brush device is mounted by default, operation S1125 may be omitted. The cleaner body (handy) operation mode is not necessarily limited, but may be divided into jet mode-ultra-powerful mode-powerful mode-normal mode in order of strongest suction force. However, this is only an example, and more diverse modes or simpler modes may be provided in order of strength of suction force. Normally, the cleaner body (handy) operation mode on which the brush device 120 is not mounted has stronger suction power than a brush operation mode on which the brush device 120 is mounted. This is because, when the brush device 120 is mounted and the suction force is high, the brush device 120 may stick to the floor. When it is determined that the brush device 120 is mounted on the cleaner body 1000, the at least one main processor 1011 of the cleaner body 1000 may determine whether the mounted brush device 120 is a brush or a wet mop, in operation S1129. As a result of the determination, when the mounted brush device 120 is determined as a wet mop, the wireless vacuum cleaner 3000 operates as the wet mop mode, in operation S1131. The wet mop mode is a mode in which an end of the cleaner body 1000 sprays water together during cleaning to facilitate mopping. When the brush device 120 mounted in the brush mode is a brush rather than a wet mop, a cleaning operation may be performed in operation S1133. In this case, similar to the handy operation mode, the brush cleaning operation mode may be divided into jet mode-ultra-powerful mode-powerful mode-normal mode in order of strongest suction force. However, this is only an example, and more diverse modes or simpler modes may be provided in order of strength of suction force.

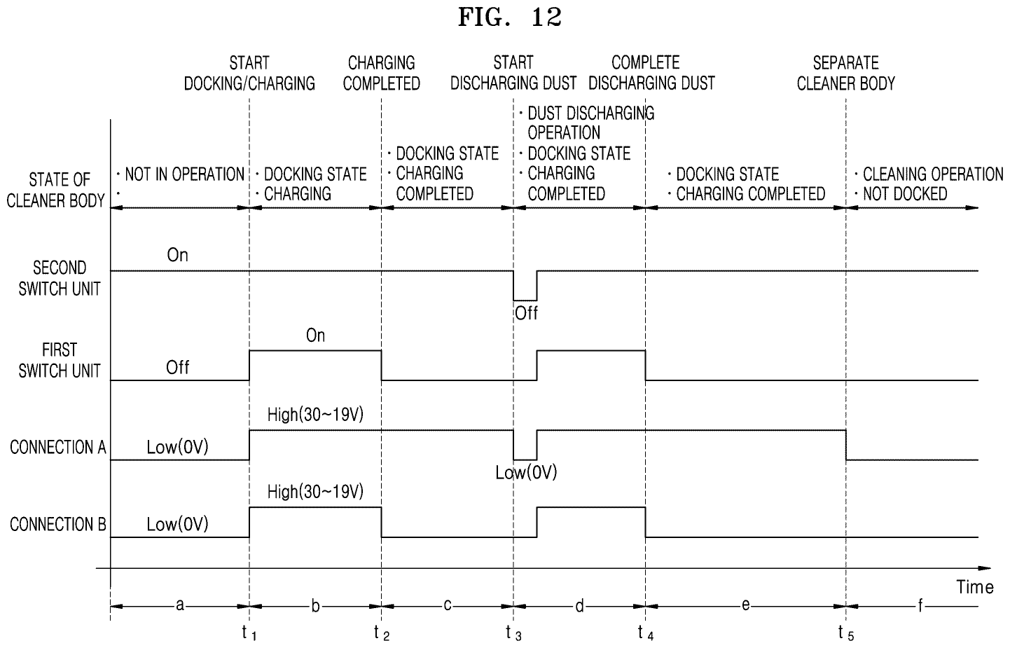

FIG. 12 is a sequence diagram for activating a vacuum cleaner body according to an operation event, according to an embodiment of the present disclosure.

Referring to FIG. 12, the x-axis is time and y-axis show a state change of each of the cleaner body 1000, the second switch unit 21, the first switch unit 11, and connection A and connection B shown in FIG. 8B. For convenience, according to the passage of time, it is assumed that 0 to t₁ is period a, t₁ to t₂ is period b, t₂ to t₃ is period c, t₃ to t₄ is period d, t₄ to t₅ is period e, and period after t₅ is period f.

In period a, the cleaner body 1000 is not mounted or coupled to the station 2000 yet. In this case, the cleaner body 1000 is in a non-operating state. In period a, the station 2000 is not charging the battery 150 of the cleaner body 1000, and thus, connection A remains in a deactivated (low) state. For example, the cleaner body 1000 may perform a cleaning operation in period a. In this case, connection B may be changed to active state.

At time point t₁, when the cleaner body 1000 is mounted or coupled to the station 2000, the state of the battery 150 may be checked, and when it is determined necessary to charge the battery 150, the station 2000 may charge the battery 150. During charging, connection A may be activated, and connection B from the battery 150 to the control unit 1100 may be activated by an operation (ON) of the first switch unit 11. At time point t₂, charging may be completed, and in period c, connection B may be deactivated. In an embodiment of the present disclosure, in period c, the battery 150 of the cleaner body 1000 to the control unit 1100 (connection B) may be disconnected.

At time point t₃, an operation event may occur on the station 2000 side. For example, the operation event may be at least one of an event in which the user pushes a user input button to discharge dust collected in the cleaner body 1000 to the station 2000, an event in which the station 2000 receives a control signal from the outside through communication, an event in which the station 2000 executes a control signal by an internal program, or an event in which the cleaner body 1000 is electrically coupled to the station 2000. In an embodiment of the present disclosure, the event in which the station 2000 receives a control signal from the outside through communication, an event in which the station executes a control signal by an internal program, and an event in which the cleaner body 1000 is electrically coupled to the station 2000 may also be an event for discharging the dust collected in the cleaner body 1000 to the station 2000.

According to the events described above, the processor 203 may activate the battery control unit 155 by performing on-off switching on the second switch unit 21 based on the operation event, and the battery control unit 155 may activate the control unit 1100 by controlling a switching operation of the first switch unit 11 to enable connection B between the battery 150 and the control unit 1100.

When dust discharge is completed at time point t₄, in period e, an operation of the first switch unit 11 may block connection B (battery 150-control unit 1100) so that the wireless vacuum cleaner 3000 enters the standby mode for minimizing power consumption.

When the cleaner body 1000 is separated from the station 2000 at time point t₅, the cleaner body 1000 may perform a cleaning operation while operating the first suction motor 111. When the cleaner body 1000 is separated from the station 2000 at time point t₅, the cleaner body 1000 is in an inactive state and may thus remain in a deactivated state until the user presses a cleaning operation start button. In other words, no information may be displayed through the output interface 173 of the cleaner body 1000 until the user separates the cleaner body 1000 and presses the cleaning operation start button. However, before the user separates the cleaner body 1000 and presses the cleaning operation start button, the cleaner body 1000 must display a battery charging state, an SW version, brush mode-related information, or the like through the output interface 173, for example. Accordingly, by using blockage of connection A (on->off) due to separation of the cleaner body 1000 from the station 2000 at time point t₅ of FIG. 12 as a signal, the battery control unit 155 may be activated, and when the battery control unit 155 is activated, blockage of connection B between the control unit 1100 and the battery control unit 155 may be released to activate the control unit 1100. At least one main processor 1011 of the activated control unit 1100 may control the output interface 173 to display necessary information.

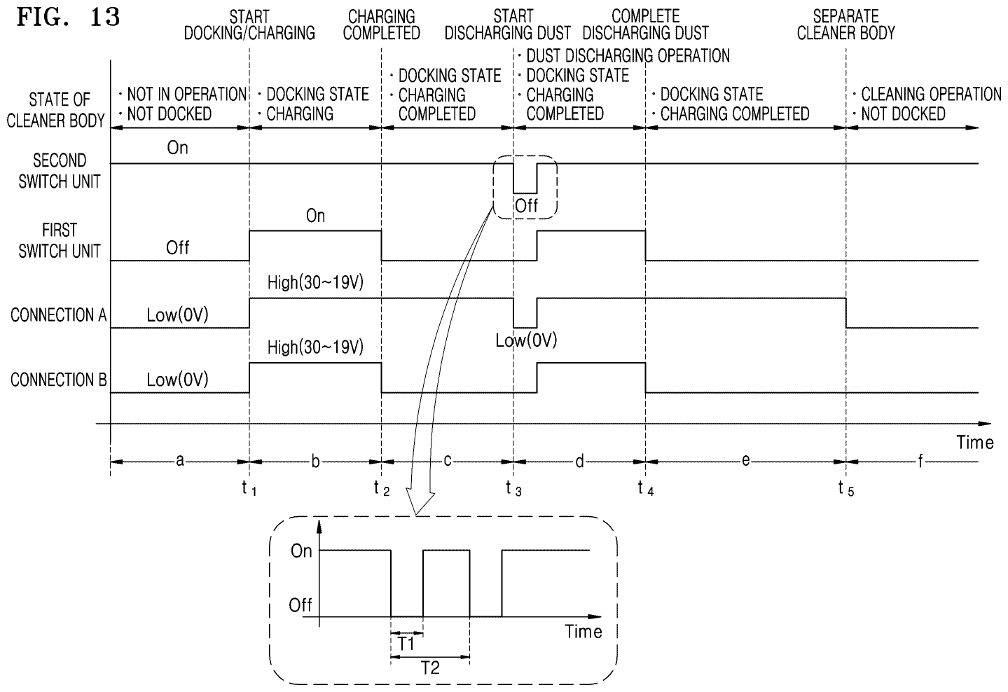

FIG. 13 is a sequence diagram showing that a switching pattern is changed according to an operation event, according to an embodiment of the present disclosure.

FIG. 13 shows a more detailed switching pattern of the second switch unit 21 when the operation event occurs in the sequence diagram of FIG. 12. In an embodiment of the present disclosure, when the operation event—e.g., dust discharge start event-occurs at time point t3 and the processor 203 of the station 2000 operates the second switch unit 21 to activate the cleaner body 1000, the operated PWM switching may be varied to transfer what the operation event is, to the battery control unit 155.

Referring to FIG. 13, the switching pattern of the second switch unit 21 does not simply perform on-off-on operation, but may vary the number of on-off operations and a duty ratio (ratio of T1/T2) and notify the battery control unit 155 of a type of the operation event. Because various switching patterns of the second switch unit 21 are shown in FIG. 14 and a description thereof is made, the descriptions thereof are omitted herein.

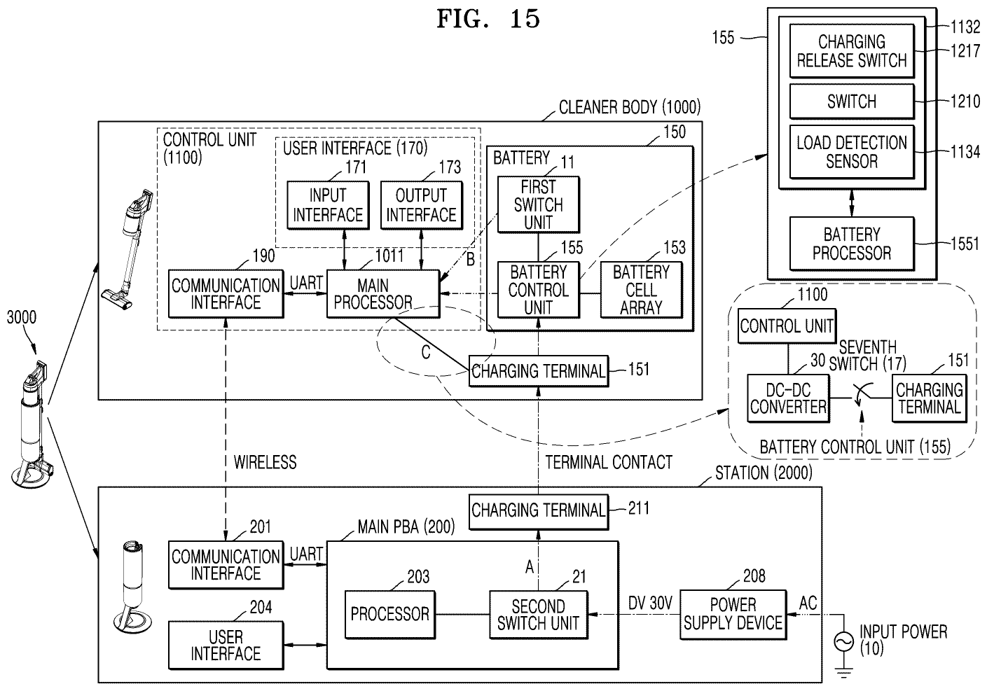

FIG. 15 is a block diagram of a wireless vacuum cleaner according to an embodiment of the present disclosure.

The block diagram according to FIG. 15 differs from the block diagram of FIG. 8B in that, in the former, connection C through which the control unit 1100 of the cleaner body 1000 may receive power directly from the power supply device 208 of the station is added. Because configurations of the cleaner body 1000 and the station 2000 are identical to those in FIG. 8B, and redundant descriptions from among the descriptions made with reference to FIG. 8B are omitted and an operation according to connection C is further described.

The processor 203 of the station 2000 may control the internal components of the station 2000 by receiving DC power from an SMPS and control a charging connection for supplying power to the battery 150 of the cleaner body 1000. The processor 203 of the station 2000 may control the second switch unit 21, the communication interface 201, the user interface 204, or the like. The user interface 204 may include a user input button, and when the user input button is pushed, the second suction motor 207 may be driven and the dust collected in the cleaner body 1000 may be sucked into the dust bin of the station 2000.

The control unit 1100 including the at least one main processor 1011 of the cleaner body 1000 may be activated by receiving power from the battery 150 and may be responsible for overall control of the cleaner body 1000.

In an embodiment of the present disclosure, when the cleaner body 1000 is docked and coupled to the station 2000 and charging of the battery 150 is completed, the processor 203 of the station 2000 or the battery control unit 155 may block power supply from the battery 150 to the cleaner body 1000 (blocking connection B in FIG. 8B), thereby minimizing power consumed in the cleaner body 1000. Blocking power from the battery 150 to the control unit 1100 (blocking connection B) in the cleaner body 1000 may reduce power consumption when the cleaner body 1000 is left for a long period of time without cleaning or when the cleaner body 1000 is left at the station 2000 for a long time, thereby improving natural discharge.

In an embodiment of the present disclosure, when power from the battery 150 to the cleaner body 1000 is completely blocked due to long-term neglect in a state in which the station 2000 and the cleaner body 1000 are coupled, the battery control unit 155 may control the first switch unit 11 to shut down (block connection A) the battery 150.

In an embodiment of the present disclosure, before the battery 150 is shut down by the battery control unit 155, the control unit 1100 of the cleaner body 1000 may be activated while the battery 150 is in a shut-down state so that the battery control unit 155 may activate connection C (control unit 1100-charging terminal 151) so that the output interface 173 or the like may continuously display information. Connection C may be performed by the battery control unit 155, or according to an embodiment of the present disclosure, may be performed by the processor 203 of the station 2000. According to an embodiment of the present disclosure, the battery control unit 155 blocks connection B and performs connection C before blocking connection A, so that the control unit 1100 of the cleaner body 1000 may always remain in an active state by the power supply device 208 of the station 2000. When the control unit 1100 of the cleaner body 1000 directly receives power from the power supply device 208 of the station 2000 through the charging terminal 151, DC voltage provided from the power supply device 208 is about 19 to 30 V, and thus, a DC-DC converter 30 for properly reducing the pressure thereof may be required. In addition, a seventh switch 17 for connecting-blocking connection B may be required. The seventh switch 17, which is an electronic switch, may include a relay, a transistor (TR), an FET, an IGBT, or the like, but is not limited thereto. The seventh switch 75 may be controlled by the battery control unit 155.

In the state in which connections A and B are blocked and only connection C is made, when the user presses a dust discharge button—user input button—of the user interface 204 of the station 2000, an operation event for discharging dust may occur. In order to activate the cleaner body 1000 and collect dust in the dust bin based on the operation event, the processor 203 may operate the second switch unit 21. When the second switch unit 21 is operated, the battery 150 is woken up so that connection A is activated, and when the battery control unit 155, which is also activated by the activation of the battery 150, may block connection C. When connection A is made and connection C is blocked, the battery control unit 155 of the cleaner body 1000 may activate the control unit 1100 including the at least one main processor 1011. In other words, even in the state where the battery 150 is shut down, the battery control unit 155 may be activated through an on-off operation of the second switch unit 21 due to an operation event occurring in the station 2000, without clicking on a separate button or transmitting signals, the battery control unit 155 may activate the control unit 1100 of the cleaner body 1000, and the control unit 1100 may detect and recognize an operation of the station 2000.

Accordingly, the activated battery control unit 155 may sequentially block connection C, connection B between the control unit 1100 and the battery 150 may be activated, and power from the battery 150 may be supplied so that the main processor 1011 including the control unit 1100 may be activated.

As such, the processor 203 of the station 2000 may operate the second switch unit 21 according to an operation event so that the battery control unit 155 is activated, thereby minimizing power consumption in the battery 150 of the cleaner body 1000. In particular, power consumption and natural discharge loss of the battery 150 may be minimized under conditions where the wireless vacuum cleaner 3000 is left unattended for a long period of time.

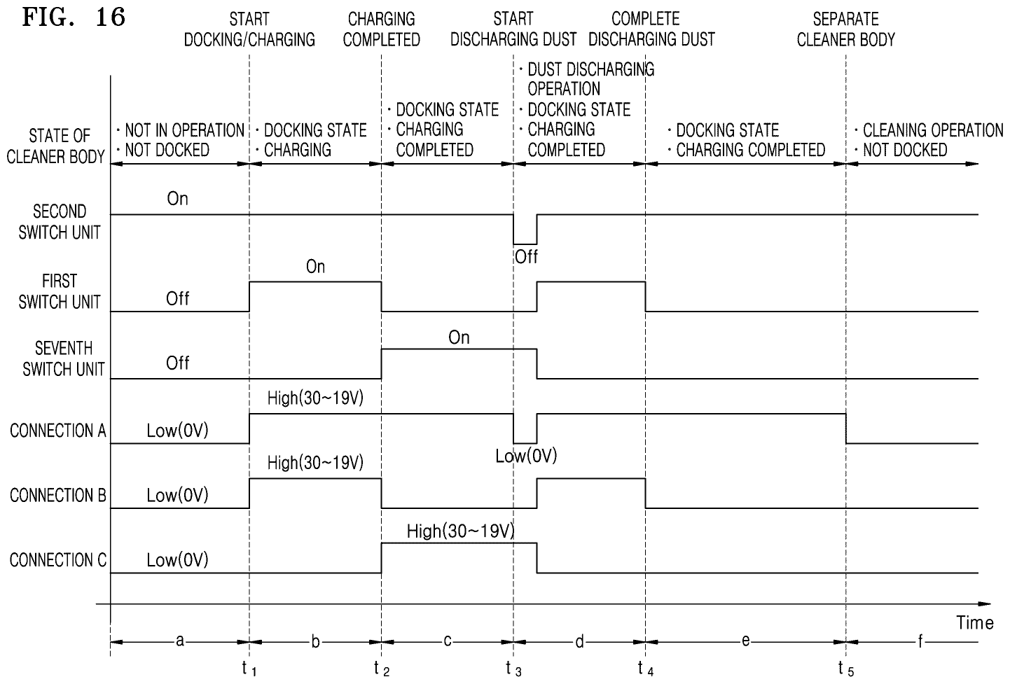

FIG. 16 is a sequence diagram showing that a switching pattern is changed according to an operation event when connection C is present, according to an embodiment of the present disclosure.

Referring to FIG. 16, a waveform diagram related to connection C is added to the sequence diagram according to FIG. 12.

In FIG. 16, the x-axis is time and y-axis show a state change of each of the cleaner body 1000, the second switch unit 21, the first switch unit 11, and connection A and connection B shown in FIG. 15. For convenience, according to the passage of time, it is assumed that 0 to t₁ is period a, t₁ to t₂ is period b, t₂ to t₃ is period c, t₃ to t₄ is period d, t₄ to t₅ is period e, and period after t₅ is period f.

In period a, the cleaner body 1000 is not mounted or coupled to the station 2000 yet. In this case, the cleaner body 1000 is in a non-operating state. Accordingly, the first switch unit 11 and the second switch unit 21 are also in a non-operating state. In period a, the station 2000 is not charging the battery 150 of the cleaner body 1000, and thus, connection A remains in a deactivated (low) state.

At time point t₁, when the cleaner body 1000 is mounted or coupled to the station 2000, the state of the battery 150 may be checked, and when it is determined necessary to charge the battery 150, connection A may be activated so that the station 2000 may charge the battery 150. While the battery 150 is charged, the first switch unit 11 is operated so that connection B is activated, and the battery 150 may supply power to the control unit 1100. As charging is completed at time point t₂, connection B is deactivated in period c, and the battery control unit 155 stops the operation of the first switch unit 11, power from the battery 150 to the control unit 1100 of the cleaner body 1000 may be blocked (connection B is blocked). In an embodiment of the present disclosure, in period c, in order to minimize power consumption, a compensation charge operation from the station 2000 to the cleaner body 1000 may also be stopped to enter the standby mode. In order to continuously display basic information in the cleaner body 1000, in period c, the seventh switch 17 may be operated by the battery control unit 155 so that connection C may be activated, and the control unit 1100 of the cleaner body 1000 may directly receive power from the power supply device 208 of the station 2000. Accordingly, in period c, there is no consumption of the battery 150 (connection B is blocked), but an operation (displaying information or the like) by the control unit 1100 the cleaner body 1000 may be continuously performed.

At time point t₃, an operation event occurs. According to the operation event, the processor 203 of the station 2000 may operate the second switch unit 21, and due to the activated connection A, the battery 150 of the cleaner body 1000 and the battery control unit 155 may be activated. The activated battery control unit 155 may turn off the seventh switch 17 to release connection C, and as power is supplied (connection B is turned on) to the cleaner body 1000, the control unit 1100 of the cleaner body 1000 may be activated.

When discharging of dust is completed at time point t₄, in period e, power connection from the battery 150 to the cleaner body 1000 may be blocked (connection B is blocked) again, and the wireless vacuum cleaner 3000 may enter the standby mode in which power consumption is minimized. In this case, the battery control unit 155 may selectively activate (turn on) connection C again.

When the cleaner body 1000 is separated from the station 2000 at time point t₅, the cleaner body 1000 may perform a cleaning operation while operating the first suction motor 111. In this case, although not shown in FIG. 16, the battery 150 and the control unit 1100 of the cleaner body 1000 may be connected (connection B) so that the control unit 1100 may be in an active state.

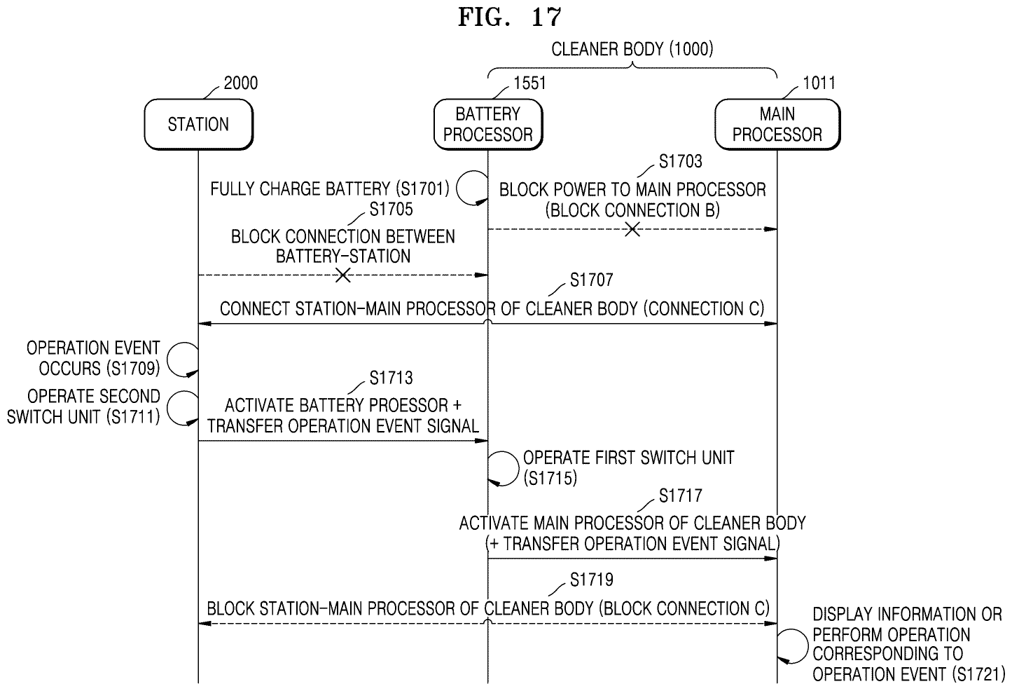

FIG. 17 is a sequence diagram showing that the vacuum cleaner body is activated when the connection C is present, according to an embodiment of the present disclosure.

Referring to FIG. 17, a sequence diagram is shown with the station 2000, the battery control unit 155, and the control unit 1100 of the cleaner body 1000 as the main elements of operation.

First, in operation S1701, the battery 150 may be fully charged through the charging terminal 211 of the station 2000. When the battery 150 is fully charged, the battery 150 may block connection between the control unit 1100 and the battery 150, in operation S1703, so that no more power is consumed in the control unit 1100.

In operation S1705, the battery control unit 155 may also block connection between the battery 150 and the station 2000 (connection A) so that no more power is consumed in the battery pack (battery 150, battery control unit 155, or the like). In this case, the battery control unit 155 or the processor 203 of the station may turn on connection C, which is between the station 2000 and the control unit 1100 of the cleaner body 1000, so that the cleaner body 1000 may perform operations without being deactivated by the control unit 1100, without consuming the battery 150. When operation S1707 is completed, the cleaner body 1000 may be in a state in which no more power is consumed by the battery 150.

In operation S1709, an operation event may occur on the station 2000 side. The operation event may be at least one of an event in which the user pushes a dust discharge button (user input button) to discharge dust from the station 2000, an event in which the station 2000 receives a control signal from the outside through communication, an event of executing a control signal by an internal program stored in the memory 202 of the station 2000, or an event in which the cleaner body 1000 is coupled to the station 2000. In the event in which the cleaner body 1000 is coupled to the station 2000, the cleaner body 1000 is a main body of an automatic mobile cleaner (robot cleaner), and the event in which the cleaner body 1000 is electrically coupled to the station 2000 may be an event in which the main body of the automatic mobile vacuum cleaner is docked to the station 2000 and electrically coupled to the station 2000.

In operation S1711, when an operation event occurs, the processor 203 of the station 2000 may operate the second switch unit 21. In an embodiment of the present disclosure, the processor 203 may vary a PWM switching pattern for operating the second switch unit 21, depending on the type of operation event.

In operation S1713, the battery 150 and the battery control unit 155 may be activated by an operation of the second switch unit 21. In addition, the battery control unit 155 may recognize the PWM switching pattern through which the processor 203 of the station 2000 operates the second switch unit 21, and determine which operation event has occurred.

The battery control unit 155 may operate the first switch unit 11, in operation S1715, and activate the control unit 1100 on the cleaner body 1000 side, in operation S1717. In addition, when the first switch unit 11 is operated, the first switch unit 11 is operated with a PWM switching pattern corresponding to the determined operation event or with a corresponding pattern, so that the main processor 1011 of the control unit 1100 may recognize what the operation event occurring on the station 2000 side is. The main processor 1011 may recognize a PWM switching pattern of the first switch unit 11, and determine a type of an operation event occurring in the station 2000 based on a mapping table of an operation event stored in the memory 180−(PWM) switching pattern.

In operation S1719, the control unit 1100 of the cleaner body 1000 may be activated and the battery control unit 155 may release connection C. In other words, the control unit 1100 may then receive power from the battery 150, and thus power supply from the station 2000 is not necessary. Accordingly, the battery control unit 155 may release connection C.

In operation S1721, the main processor 1011 of the control unit 1100 of the cleaner body 1000 may control the cleaner body 1000 to perform a required operation according to the determined operation event. For example, when the operation event must display specific information, the corresponding information may be displayed through the output interface 173, or when the operation event is emptying the dust bin 110, an operation of emptying the dust bin 110 may be performed.

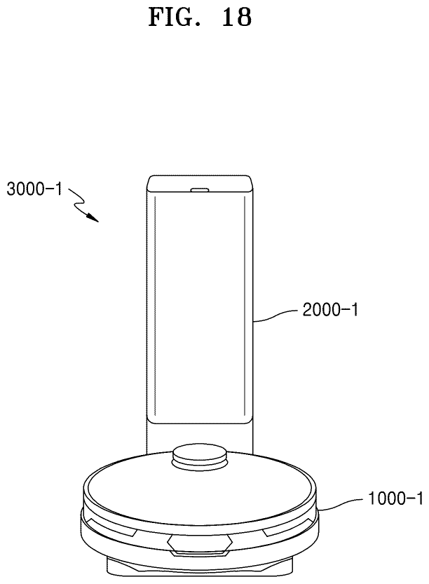

FIG. 18 is a diagram showing an automatic mobile vacuum cleaner according to an embodiment of the present disclosure.

In an embodiment of the present disclosure, a wireless vacuum cleaner 3000-1 may be a robot cleaner, and a cleaner body 1000-1 may be an automatic mobile vacuum cleaner body. In the same manner as described above, the cleaner body 1000-1 may be electrically disconnected from a station 2000-1 and then may be activated by a switch switching according to an operation event occurring on the station 2000-1 side. In this case, a battery and battery control unit of the cleaner body 1000-1 are activated first and then a first control unit of the cleaner body 1000-1 may be activated. However, the present disclosure is not limited thereto, and the battery, the battery control unit, and the first control unit of the cleaner body 1000-1 may be activated together by switching on the station 2000-1 side.

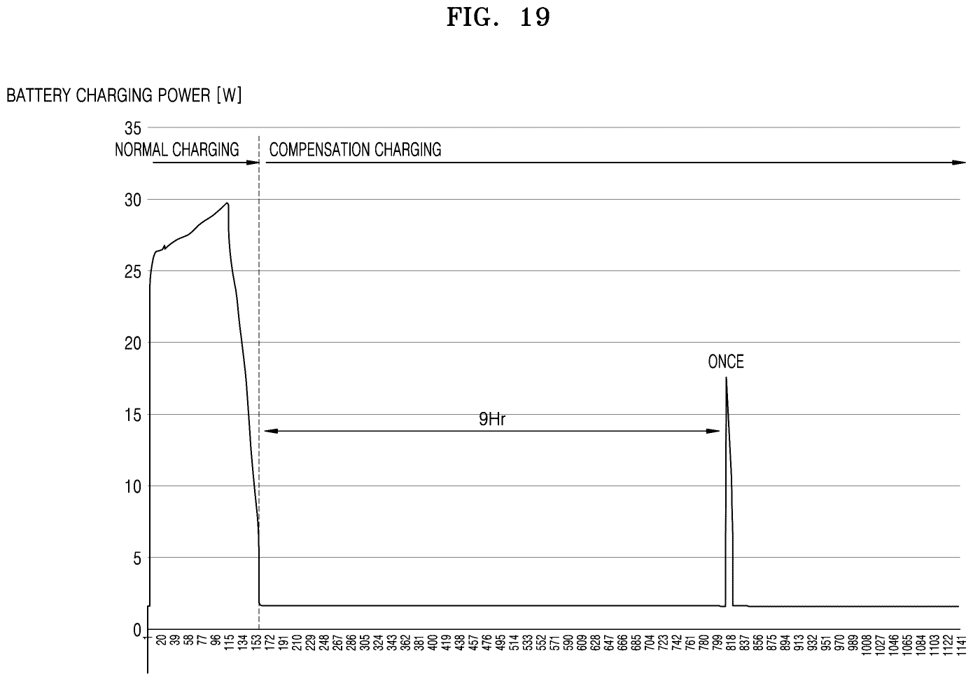

FIG. 19 is a waveform diagram showing a compensation charging cycle of a wireless vacuum cleaner in standby mode according to an embodiment of the present disclosure.

FIG. 19 shows a waveform diagram of a compensation charging cycle in which the wireless vacuum cleaner 3000 blocks charging in the standby mode so as to reduce the compensation charging cycle, according to an embodiment of the present disclosure. Compared to the compensation charging performed every hour in FIGS. 3A and 3B described above, it can be seen that compensation charging is performed every 9 hours, thereby increasing lifespan of the battery 150 and minimizing unwanted power loss in the wireless vacuum cleaner 3000. The compensation charging cycle of 9 hours in FIG. 19 is only an example, and a cycle may be shorter or longer depending on the specifications of the battery 150 and the design specifications of the user. However, when switching of a switch unit on the station 2000 side according to an operation event is used as a wake-up signal on the battery 150 side, according to an embodiment of the present disclosure, a charging cycle may be significantly increased compared to the case of FIGS. 3A and 3B, thereby minimizing power loss.

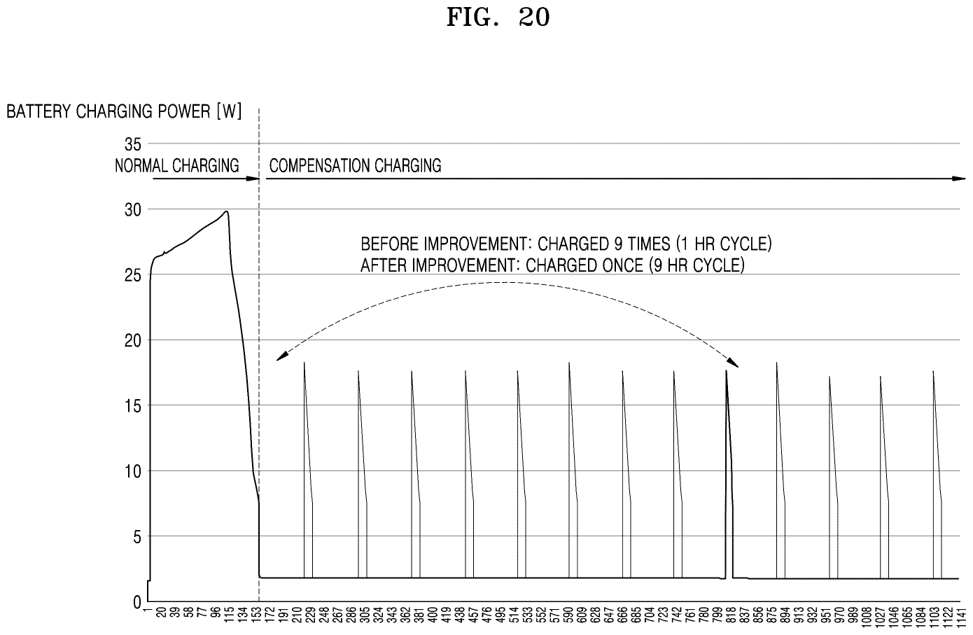

FIG. 20 shows a waveform diagram for comparing before and after improvement of the compensation charging cycle of a wireless vacuum cleaner in standby mode according to an embodiment of the present disclosure.

Referring to FIG. 20, when switching of a switch unit on the station 2000 according to an operation event is used as a wake-up signal on the battery 150 side, according to an embodiment of the present disclosure, it can be seen that the compensation charging cycle is increased to 9 hours. Accordingly, compared to a case where compensation charging must be performed at regular intervals of 1 hour without using switching of a switch unit on the station 2000 side according to an operation event as a wake-up signal on the battery 150 side, power loss may be minimized and the lifespan of the battery 150 may be extended, according to the present disclosure.

Disclosed is an electric device configured to activate a first device, according to an embodiment of the present disclosure. The electric device includes a first device and a second device, the first device including a battery, wherein the second device includes a processor configured to detect an operation event and transmit a control signal corresponding to the operation event to a battery processor of the first device, the first device includes a first switch unit connecting between the battery and a main processor, the battery processor configured to operate the first switch unit based on the control signal corresponding to the operation event, and the main processor activated by the battery based on the first switch unit being operated, the electric device includes a wireless vacuum cleaner device, the first device includes a cleaner body of the wireless vacuum cleaner device, and the second device includes a station of the wireless vacuum cleaner device.

According to an embodiment of the present disclosure, the second device further includes a second switch unit, the processor is configured to detect an operation event and operate the second switch unit based on the operation event, to activate the battery processor, and the turning-on of the first switch unit by the battery processor based on a control signal corresponding to the operation event includes operating, by the battery processor activated based on the second switch unit being operated, the first switch unit based on the control signal corresponding to the operation event.

According to an embodiment of the present disclosure, the operation event occurs when the electrical connection between the second device and the battery is blocked.

According to an embodiment of the present disclosure, the activation of the battery processor based on the second switch unit being turned on includes starting charging from the second device to the battery when the second switch unit is turned on, and activating, when the charging starts, the battery processor by a voltage generated at the charging terminal of the battery.

According to an embodiment of the present disclosure, before an operation event occurs, when the battery is charged to a predetermined level, the battery processor is configured to control such that the charging from the second device to the battery is blocked.

According to an embodiment of the present disclosure, when the battery is charged to the predetermined level, the battery processor is configured to block the electrical connection between the battery and the main processor.

According to an embodiment of the present disclosure, the battery processor is configured to block the electrical connection between the battery and the main processor and control such that the main processor and the charging terminal of the second device are electrically connected.

According to an embodiment of the present disclosure, the battery processor is activated by using the turning-on of the second switch unit as a wake-up signal, and the activated battery processor is configured to release the connection between the main processor and the charging terminal of the second device and control the battery to supply power to the main processor.

According to an embodiment of the present disclosure, the battery processor is activated by using the turning-on of the second switch unit as a wake-up signal, and the activated battery processor is configured to control the battery to supply power to the main processor.

According to an embodiment of the present disclosure, the activation of the battery processor by using the turning-on of the second switch unit as a wake-up signal includes activating, when the second switch unit is turned on, the battery processor by using a charging signal detected at the charging terminal of the battery as the wake-up signal.

According to an embodiment of the present disclosure, the main processor is configured to determine, when the second switch unit is operated, a type of an operation event according to on-off patterns.

According to an embodiment of the present disclosure, the type of the operation event varies depending on the lengths of on and off periods of the second switch unit when the second switch unit is operated and the number of on and off repetitions of the second switch unit.

According to an embodiment of the present disclosure, the operation event occurs when the electrical connection between the main processor and the battery is blocked.

According to an embodiment of the present disclosure, the operation event may be at least one of an event in which a user input button is pushed, an event in which the second device receives a control signal from the outside of the electric device through communication, an event in which a control signal by an internal program of the second device is executed, or an event in which the first device is coupled to the second device.

According to an embodiment of the present disclosure, the control signal received by the second device from the outside of the electric device through communication may be a control signal received from at least one of a mobile terminal, a computing device, or a server.

According to an embodiment of the present disclosure, the control signal by the internal program of the second device is a control signal that is periodically executed.

According to an embodiment of the present disclosure, a cleaner body is an automatic mobile vacuum cleaner body, and the event in which the first device is electrically coupled to the second device is an event in which the automatic mobile vacuum cleaner body is docked and electrically coupled to the second device.

According to an embodiment of the present disclosure, a wireless vacuum cleaner device configured to activate a wireless vacuum cleaner body is disclosed. The wireless vacuum cleaner device is a wireless vacuum cleaner device including a wireless vacuum cleaner body and a station, the wireless vacuum cleaner body including a battery. The station includes a second switch unit capable of electrically connecting the battery and the station, and a processor configured to detect an operation event and control such that the battery and the station are electrically connected to each other by operating the second switch unit based on the operation event, and the wireless vacuum cleaner body includes a battery processor activated based on the second switch unit of the station being turned on.

According to an embodiment of the present disclosure, the operation event occurs in a state in which the electrical connection between the battery and the station is blocked.

According to an embodiment of the present disclosure, the wireless vacuum cleaner body further includes a main processor configured to control the wireless vacuum cleaner body, and a first switch unit capable of connecting between the battery and the main processor, wherein the activated battery processor operates the first switch unit so that the main processor is activated.

A method according to an embodiment of the present disclosure may be implemented as program commands executable by various computer means and may be recorded on a computer-readable medium. The computer-readable medium may include program commands, data files, data structures, and the like separately or in combinations. The program commands recorded on the computer-readable medium may be specially designed and configured for the present disclosure or may be well-known to and be usable by one of ordinary skill in the art of computer software. Examples of the computer-readable recording medium include a magnetic medium such as a hard disk, a floppy disk, or a magnetic tape, an optical medium such as a CD-ROM or a DVD, a magneto-optical medium such as a floptical disk, and a hardware device specially configured to store and execute program commands such as a ROM, a RAM, or a flash memory. Examples of the program commands include advanced language codes that may be executed by a computer by using an interpreter or the like as well as machine language codes made by a compiler.

Some embodiments of the present disclosure may also be realized in a form of a recording medium including instructions executable by a computer, such as a program module executed by a computer. A computer-readable medium may be an arbitrary available medium accessible by a computer, and includes all volatile and non-volatile media and separable and non-separable media. Further, the computer-readable medium may include both a computer storage medium and a communication medium. Examples of the computer storage medium include all volatile and non-volatile media and separable and non-separable media, which have been implemented by an arbitrary method or technology, for storing information such as computer-readable instructions, data structures, program modules, and other data. Communication media typically includes computer readable instructions, data structures, program modules, or other data in a modulated data signal such as a carrier wave, or other transmission mechanism, and includes any information delivery medium. In addition, some embodiments of the present disclosure may be implemented as a computer program or computer program product that includes instructions executable by a computer, such as a computer program executed by a computer.

A machine-readable storage medium may be provided in a form of a non-transitory storage medium. Here, the “non-transitory storage medium” only denotes a tangible device and does not contain a signal (for example, electromagnetic waves). This term does not distinguish a case where data is stored in the storage medium semi-permanently and a case where the data is stored in the storage medium temporarily. For example, the “non-transitory storage medium” may include a buffer where data is temporarily stored.

According to an embodiment of the present disclosure, a method according to various embodiments disclosed in the present specification may be provided by being included in a computer program product. The computer program products are products that can be traded between sellers and buyers. The computer program product may be distributed in a form of machine-readable storage medium (for example, a compact disc read-only memory (CD-ROM)), or distributed (for example, downloaded or uploaded) through an application store or directly or online between two user devices (for example, smartphones). In the case of online distribution, at least a part of the computer program product (for example, a downloadable application) may be at least temporarily generated or temporarily stored in a machine-readable storage medium, such as a server of a manufacturer, a server of an application store, or a memory of a relay server.

1. An electric device comprising:
a wireless vacuum cleaner device including:
a first device including a cleaner body, a battery, a battery processor, a main processor, and a switch unit to connect between the battery and the main processor,
a second device including a station and a processor configured to detect an operation event and transmit a control signal corresponding to the operation event to the battery processor of the first device,
wherein the battery processor is configured to operate the switch unit based on the control signal corresponding to the operation event, and cause the main processor to be activated by the battery based on the switch unit being operated.

2. The electric device of claim 1,
wherein the switch unit is a first switch unit, and the second device further comprises a second switch unit,
the processor is further configured to:
activate the battery processor by detecting the operation event and operate the second switch unit based on the operation event, and
the operating of the first switch unit, performed by the battery processor, turns on the first switch unit and comprises operating, by the battery processor, the first switch unit based on the control signal corresponding to the operation event according to the battery processor being activated based on the second switch unit being operated to be turned on.

3. The electric device of claim 1,
wherein the operation event occurs in a state in which an electrical connection between the second device and the battery is blocked.

4. The electric device of claim 2,
wherein the battery processor being activated based on the second switch unit being turned on comprises,
while the second switch unit is turned on, starting charging from the second device to the battery, and upon the charging being started, activating the battery processor by a voltage generated at a charging terminal of the battery.

5. The electric device of claim 1,
wherein, based on the battery being charged to a predetermined level before the operation event occurs, the battery processor is configured to block charging from the second device to the battery.

6. The electric device of claim 1,
wherein, based on the battery being charged to a predetermined level, the battery processor is configured to block an electrical connection between the battery and the main processor.

7. The electric device of claim 6,
wherein the battery processor is configured to block the electrical connection between the battery and the main processor and control the main processor and a charging terminal of the second device to be electrically connected to each other.

8. The electric device of claim 7, wherein the switch unit is a first switch unit, and the second device further comprises a second switch unit,
wherein the battery processor is activated by using a turning-on of the second switch unit as a wake-up signal, the battery processor while activated is configured to release a connection between the main processor and the charging terminal of the second device, and control the battery to supply power to the main processor.

9. The electric device of claim 2,
wherein the battery processor is activated by using turning-on of the second switch unit as a wake-up signal, and the battery processor while activated is configured to control the battery to supply power to the main processor.

10. The electric device of claim 9,
wherein the battery processor is activated by using the turning-on of the second switch unit as a wake-up signal comprises, while the second switch unit is turned on, activating the battery processor by using a charging terminal detected at the charging terminal of the battery as a wake-up signal.

11. The electric device of claim 2,
wherein the main processor is configured to determine, based on the second switch unit being operated, a type of the operation event according to an on-off pattern.

12. The electric device of claim 11,
wherein a type of the operation event varies depending on lengths of on and off periods of the second switch unit while the second switch unit is operated and a number of on and off repetitions of the second switch unit.

13. The electric device of claim 1, wherein
the operation event occurs in a state in which an electrical connection between the main processor and the battery is blocked.

14. The electric device of claim 1,
wherein the operation event is at least one of a user input button being pushed, the second device receiving a control signal from outside of the electric device through communication, executing of a control signal by an internal program of the second device, and the first device being coupled to the second device.

15. The electric device of claim 14,
wherein the control signal received by the second device from outside of the electric device through communication is from at least one of a mobile terminal, a computing device, and a server.

16. The electric device of claim 14,
wherein the control signal by an internal program of the second device is executed periodically.

17. The electric device of claim 14,
wherein the cleaner body is an automatically movable cleaner body, and
the operation event of the first device being coupled to the second device is an event where the automatically movable cleaner body is docked to the second device so that the cleaner body is electrically coupled to the second device.

18. A wireless vacuum cleaner device including a wireless cleaner body having a battery and a station, the wireless vacuum cleaner device comprising:
the station including:
a second switch configured to electrically connect the battery and the station, and
a processor configured to detect an operation event and to control the battery to electrically connect to the station by operating the second switch based on the detected operation event, and
the wireless cleaner body including:
a battery processor configured to be activated based on the second switch of the station being turned on.

19. The wireless vacuum cleaner device of claim 18,
wherein the operation event occurs when an electrical connection between the battery and the station is blocked.

20. The wireless vacuum cleaner device of claim 18,
wherein the wireless cleaner body further including:
a main processor configured to control the wireless cleaner body, and
a first switch that is capable of connecting the battery and the main processor,
wherein the main processor is activated by the first switch controlled by the activated battery processor.
